(19) United States
(12) Patent Application Publication
(10) Pub. No.: US 2012/0323619 A1
(43) Pub. Date: Dec. 20, 2012

(54) ENVIRONMENTAL IMPACT ASSESSMENT SYSTEM AND METHOD

(76) Inventors: Yann O. Risz, Mill Valley, CA (US); Lawrence E. Goldenhersh, Rancho Santa Fe, CA (US); Corinne Reich-Weiser, Menlo Park, CA (US); Chen Lin, Shandong Province (CN); Daniel L. Dias, Cambridgeshire (GB)

(21) Appl. No.: 13/402,870

(22) Filed: Feb. 22, 2012

Related U.S. Application Data
(60) Provisional application No. 61/445,521, filed on Feb. 22, 2011.

(51) Int. Cl. G06Q 10/00

(52) U.S. Cl. 705/7.11

(57) ABSTRACT

A method for assessing costs associated with an organization or its supply chain is provided. The method includes: accessing a first set of data relating to the organization or the supply chain, wherein the first set of data includes environmental flows, products data, or activities data associated with the organization or the supply chain; accessing one or more databases indexed by at least a portion of the environmental flows, products data, or activities data, the one or more databases including one or more of: a database including societal costs; a database including current internal costs, the current internal costs representing costs internalized by the organization or the supply chain; and a database including future internal costs, the future internal costs representing costs projected to be internalized by the organization or the supply chain; and applying the first set of data to the one or more databases.

### CROSS-REFERENCE TO RELATED APPLICATION(S)

This utility patent application claims priority to and the benefit of U.S. Provisional Application Ser. No. 61/445,521, filed Feb. 22, 2011, entitled Environmental Impact Assessment System and Method, the entire content of which is incorporated herein by reference.

### BACKGROUND

1. Field

Aspects of embodiments according to the present invention relate in general to an environmental impact assessment system and method.

2. Description of Related Art

For years, Economic Input Output (EIO) analysis has been used to try to articulate the societal impact of human activity in physical terms. The United Nations, for example, has tried to understand, in physical impact terms, the global societal impact of human activity. Many of the impacts included in EIO analysis of this type would be considered “external” costs to industry-impacts for which industry has not been made responsible and, therefore, are not included in either financial or strategic planning. For example, the societal cost of health damage inflicted on the peoples of developing nations by water pollution allowed to occur in the course of product manufacturing because of lax or non-existent environmental laws is currently not a cost industry is forced to pay or even recognize in its business operations.

U.S. Pat. No. 7,797,183, the content of which is hereby incorporated by reference, describes a computer system to articulate the physical impacts (later referred to as external cost) of separately accountable business units in dollar terms and assign a relative score for the ranking and comparison of business units according to this cost.

EIO suffers drawbacks because its macro approach is not precise enough, from a scientific standpoint, to provide data that can be used to draw comparisons between suppliers, products, or companies within a particular industry. EIO data is only industry specific, but can be useful for broadly assessing impacts or formulating public policy to address those impacts. In substance, EIO is an imprecise “top down” analysis of impacts that is not specific enough for an organization to take action.

Life Cycle Assessment (LCA), another known area, is a “bottoms up” approach to evaluating impacts that can provide the detail absent from EIO analysis. As its name suggests, LCA is typically used in the product area to describe the environmental impacts associated with the creation and delivery of a product. The “impacts” identified by LCA are expressed in physical terms (e.g. each screwdriver has 20 pounds of embodied carbon).

The cost of this detail-oriented focus of the LCA makes it impractical for use with the millions of products in the world and has forced LCA practitioners to distort real product impacts by artificially limiting product boundary lines to portions of the process that can be fully evaluated with this granular approach. For example, if a screwdriver is manufactured in a city in the interior of China, transported over land and sea to the U.S., where it is then offered for sale, LCA analysis might be limited to the impacts occurring in the U.S. because there was no access to, or cost effective and reliable way to gain access to, the manufacturing process in China.

In 2004, Sangwon Suh published a theory for leveraging the predictive power of EIO analysis to fill in the boundary gaps of LCA, producing an end-to-end analysis of the impact of a product. See Sangwon Suh, Functions, commodities and environmental impacts in an ecological-economic model, Ecological Economics 48 (2004) pp. 451-467 and Sangwon Suh et al., System Boundary Selection in Life-Cycle Inventories Using Hybrid Approaches, Environmental Science & Technology, vol. 38, no. 3, 2004, pp. 657-664. This approach is called Integrated Hybrid Life Cycle Assessment (IHLCA). While Hybrid LCA existed before, Professor Suh published a way to integrate matrices to make the process more scalable and complete. Professor Suh's work was limited to a discussion of the physical impacts—the amount of carbon embodied in a screwdriver—and did not address either the idea of articulating impacts in terms of costs or a process for doing so.

### SUMMARY

An exemplary embodiment of the present invention includes one or more of the following features taken alone or in combination to essentially enable organizations, purchasing officers, and consumers to better understand and effectively reduce the environmental impacts, and their related financial costs and risks:

In an exemplary embodiment of the present invention, a process for using the combination of environmental impacts (external or societal costs), internal costs, at-risk (future internal) costs, and the total cost of ownership (TCO, including ordinary, hidden, and contingent costs), expressed in monetary terms, to create and assign standardized EVE labeling for products. EVE stands for Environmental Value Exposure. In one embodiment, the EVE score provides an assessment for sustainability. The EVE score may be supported by auditable, standardized, and validated measurement of environmental impacts, expressed in physical and monetary terms. In an exemplary embodiment, the EVE score allows the product buyers (and, over time, the consumers) to understand the rank ordering of products according to their various costs (impact on the planet, internal costs, at-risk costs, and TCO), and to make purchase decisions accordingly.

In another exemplary embodiment of the present invention, a process for adding to Integrated Hybrid Life Cycle Assessment (IHLCA) the ability to articulate in monetary terms each of a product's environmental and financial impacts that have been identified through the application of IHLCA and financial/risk analysis tools (e.g., environmental cost of embodied fresh water consumption in a screwdriver from manufacturer X). In one embodiment, a database of societal costs for each of the environmental flows (that is, outputs of the IHLCA analysis) is created. This database is applied to each of the environmental flows of a product, company, or other organization to produce the societal (that is, externalized) costs for that product, company, or other organization, expressed in monetary terms. In one embodiment, these outputs become the societal cost component for an Environmental Value Exposure (EVE) score.

In another exemplary embodiment of the present invention, a process for applying a database of current internalized costs associated with each of the environmental flows to the IHLCA outputs (environmental flows) of an organization is provided. This process estimates the internal costs that an organization currently experiences for each of the environmental flows. In one embodiment, these outputs become the current internal cost component for an EVE score. In another embodiment, a process for building the database of current internalized costs for each environmental flow (using, for example, market prices and existing regulations) is provided.

In another exemplary embodiment of the present invention, a process for applying a database of future (that is, at-risk) internalized costs associated with each of the environmental flows to the IHLCA outputs (environmental flows) of an organization is provided. This process estimates the future internal costs that an organization may experience based on projected trends in areas such as market directions and future regulatory measures. In one embodiment, these outputs become the future internal cost component for an EVE score. In another embodiment, a process for building the database of at-risk internalized costs for each environmental flow (using, for example, market futures prices, material scarcity information, and predicted or expected regulatory changes and their impact on future prices) is provided. In still another embodiment, the databases of current internalized costs and of future (at-risk) internalized costs are combined into a single database of current and future internal costs for each of the environmental flows.

In another exemplary embodiment of the present invention, a process for automated translation of regulatory databases into price projections on environmental flows is provided. In one embodiment, the creation of a database that highlights and synthesizes information on regulations by geography and industry, and then translates this information into an at-risk price associated with environmental flows is provided. This enables understanding of what regulations will affect an organization's current and future costs from regulation and remediation.

In another exemplary embodiment of the present invention, a process for applying a database of future (that is, at-risk) internalized costs associated with the purchase of various commodities and services by an organization is provided. This process estimates the future internal costs that an organization may experience based on projected trends in areas such as market directions and resource scarcity. In one embodiment, these outputs become the future internal cost component for the EVE. In another embodiment, a process for building the database of at-risk internalized costs for each commodity or service (using, for example, market futures prices, material scarcity information, and predicted or expected regulatory changes and their impact on future prices) is provided.

In another exemplary embodiment of the present invention, a process for applying a database of ordinary, hidden, and contingent costs to a particular product type or industry is provided. This process estimates the total cost of ownership (TCO) that an organization internalizes for its use of a product type or industry. These costs are not broken down by environmental flows, and could be overlooked (for example, hidden) when only considering costs by environmental flow. In one embodiment, the TCO outputs are further augmented by the potentially hidden environmental flow costs created during the use and disposal phase of ownership using IHLCA model data and the database of current and future internal costs. In another embodiment, the TCO outputs become the TCO component for an EVE score.

In another exemplary embodiment of the present invention, a process for building a dynamic mitigation library (or dynamic mitigation databases) is provided. Although these databases could be built from custom data (e.g., engineering studies), produced with many assumptions (perhaps averaged or aged data that is not consistent with actual implementations), the main industrial players perform this type of mitigation and analysis all the time. Their experiences could thus be used to build a dynamic database that is continuously refined based on informed actual data (i.e., evergreen data). The library is a repository of mitigation implementation estimates as well as results and costs as applied to environmental problems shared by different companies or organizations. The library is continually refined based on real world experiences of numerous and often large companies who implement mitigation plans on a regular basis. This provides timely and evergreen data on the efficiencies of various mitigation options that a company facing similar problems may have to choose between. In one embodiment, the dynamic mitigation library is cloud-based. In other embodiments, dynamic libraries are provided for other databases, such as hidden or contingent costs, IHLCA tables, and monetization values of environmental impacts.

While these databases are normally built from custom data (e.g., engineering studies), produced with many assumptions (perhaps averaged or aged data that is not consistent with actual implementations), the main industrial players perform this type of mitigation and analysis all the time. Their data could be used to build a dynamic database that is continuously refined based on informed actual data (i.e., evergreen data).

In further detail, the process for maintaining the dynamic mitigation library may include maintaining a library of projects and activities (including, for example, carbon credit trading and the deployment of industrial stack scrubbers to remove toxic air emissions) that may be implemented to mitigate a specified environmental impact and for rank ordering such projects in terms of (a) impact on organization profit and loss (e.g. project costs $50 M but saves $80 M, thus resulting in $30 M addition to profit) and (b) amount of environmental (societal) impact reduced per dollar spent (e.g., project costs $50 M but reduces environmental impact by $140 M). As a further example, a water mitigation library could list 10 projects—from installation of control valves to employee training—each of which specifies the financial and environmental benefits of a given approach, expressed in simple monetary terms (e.g., $X reduced environmental impact, $Y saved to the bottom line today, $Z reduced in terms of future exposure given rising prices of water).

In still further detail, the process for maintaining the dynamic mitigation library may include a process for collecting operating data used to measure the reduction of specified environmental impact attained by a project to: (a) validate that the project reduced the impact as expected (validation) and (b) where anticipated results were not obtained, to modify the mitigation library to reflect accurate mitigation numbers and accurate measures of mitigation units/$ spent.

In another exemplary embodiment of the present invention, a process for estimating total consumption of specific commodities across the supply chain and hence (earnings) exposure to these for the company is provided.

In another exemplary embodiment of the present invention, a process for aggregating the impacts of a product, expressed in monetary terms, to create a ranking of products in terms of monetary impact is provided. These impacts can be for any or all of different dimensions, such as externalized (i.e., environmental costs not carried by the company), internalized (carried by the company today), and risks (potentially internalized by the company later). The rankings can be done on any of these dimensions, but are mostly relevant for the environmental impacts as a foundation for a product scoring system vis a vis end consumers, such as an Environmental Value Exposure (EVE) score. For example, screwdriver #1 may have 20 cents of embodied water, screwdriver #2 may have 40 cents of embodied water; screwdriver #1 may have $1.40 total environmental costs from greenhouse gas, water, and waste, and screwdriver #2 may have $1.60 in such costs).

In another exemplary embodiment of the present invention, a process for aggregating the individual product rankings into various categories, including product categories (e.g. all boxed breakfast cereal, ranked by total cost of embodied water, CO₂ and hazardous waste), geographical categories (e.g. cost of cardboard packaging of boxed breakfast cereal from China vs. US), impact categories (e.g. cost of embodied fresh water consumption, by product category) is provided.

In another exemplary embodiment of the present invention, a process for displaying (e.g., on a computer display or a display portion of a computing device) the analysis identified in the above embodiments so that the information may be readily consumed and applied by product buyers and product suppliers is provided. The displays may include graphical displays, with drill down capabilities from the graphical displays to details required for decision making.

In another exemplary embodiment of the present invention, a process for addressing with financial instruments (e.g., cap and trade) the environmental impacts that cannot be otherwise reduced cost effectively is provided. For example, the purchase of carbon credits to offset a particular amount of carbon where the purchase of offsets may be determined to be the most cost effective approach from the dynamic mitigation library discussed above.

In another exemplary embodiment of the present invention, any or all of this functionality described in the above embodiments may be incorporated into a single software platform with workflow that allows the user to seamlessly move from one phase to the next, and back again. In an exemplary embodiment, this workflow incorporates one or more features of the present invention into a user-friendly platform that makes possible the performance of a variety of interrelated activities.

In another exemplary embodiment of the present invention, a platform for implementing one or more of the disclosed embodiments is 100% cloud-based topology, but the features may also be practiced on any kind of technology platform (computing device) in other embodiments. For example, the highly distributed nature of the data collection tasks (e.g., product buyers in Columbus, Ohio collaborating with product suppliers in China and transportation providers in Hong Kong; emissions tracking from Shenzhen, China to San Diego) makes the cloud an exemplary platform for this kind of application.

In another exemplary embodiment of the present invention, a process for automated collection of operating data as part of the environmental flows information compiled and computed within a system to modify the IHLCA environmental flow calculations to reflect accurate quantities and track these quantities over time.

In an exemplary embodiment according to the present invention, a method for assessing costs associated with an organization and/or its supply chain is provided. The method includes: accessing a first set of data relating to the organization and/or the supply chain, wherein the first set of data includes environmental flows, products data, and/or activities data associated with the organization and/or the supply chain; accessing one or more databases indexed by at least a portion of the environmental flows, products data, and/or activities data, the one or more databases including one or more of: a database including societal costs, the societal costs representing costs external to the organization and the supply chain; a database including current internal costs, the current internal costs representing costs internalized by the organization or the supply chain; and a database including future internal costs, the future internal costs representing costs projected to be internalized by the organization or the supply chain; and applying the first set of data to the one or more databases to produce a corresponding one or more cost data, the one or more cost data representing the costs associated with the organization or the supply chain, the one or more cost data including a corresponding one or more of: societal cost data; current internal cost data; and future internal cost data.

In another exemplary embodiment of the present invention, a system for assessing costs associated with an organization and/or its supply chain is provided. The system includes a computer processor configured to obtain a first set of data relating to the organization and/or the supply chain. The first set of data includes environmental flows, products data, and/or activities data associated with the organization and/or the supply chain. The computer processor is coupled to one or more databases indexed by at least a portion of the environmental flows, products data, and/or activities data. The one or more databases include one or more of: a database including societal costs, the societal costs representing costs external to the organization and the supply chain; a database including current internal costs, the current internal costs representing costs internalized by the organization or the supply chain; and a database including future internal costs, the future internal costs representing costs projected to be internalized by the organization or the supply chain. The computer processor is configured to apply the first set of data to the one or more databases to produce a corresponding one or more cost data, the one or more cost data representing the costs associated with the organization or the supply chain. The one or more cost data include a corresponding one or more of: societal cost data; current internal cost data; and future internal cost data.

In yet another exemplary embodiment of the present invention, a system for enabling organizations to collaborate with respect to environmental impact mitigation plans and an effectiveness thereof is provided. The system includes a server computer coupled to a plurality of client computers individually accessible by users in a plurality of distinct organizations. The server computer is coupled to a database that includes the environmental impact mitigation plans and results indicating the effectiveness thereof, the plans and results indexed by product, industry, or environmental concern. The system is configured to: enable the users in the distinct organizations to access the plans; receive successively updated plans and updated results from users in the distinct organizations based on an actual implementation of the plans by the organizations; and enable the users to access the updated plans and updated results from the system. The database is populated with successively updated plans and results from various distinct organizations over time, thereby enabling the users in the distinct organizations to access augmented and optimized environmental mitigation plans for implementation therein.

These and other embodiments will be apparent to one of ordinary skill in the art with reference to this disclosure and accompanying drawings.

### BRIEF DESCRIPTION OF THE DRAWINGS

The patent application file contains at least one drawing executed in color. Copies of this patent or patent application publication with color drawing(s) will be provided by the Office upon request and payment of the necessary fee.

The accompanying drawings, together with the specification, illustrate exemplary embodiments of the present invention and, together with the description, serve to explain aspects and principles of the present invention.

FIG. 1 illustrates a system architecture for implementing exemplary methods of the present invention according to an exemplary embodiment of the present invention.

FIG. 2 is a legend of the different colored text boxes used in FIG. 3 through FIG. 11.

FIG. 3 is a flow diagram illustrating an overview of exemplary methods according to the present invention.

FIG. 4 is a flow diagram illustrating an example method of applying Integrated Hybrid Life Cycle Assessment (IHLCA) data to produce the societal (externalized) cost component of the Environmental Value Exposure (EVE) according to the present invention.

FIG. 5 is a flow diagram illustrating an example method of applying IHLCA data to produce the current (internalized) cost component of the Environmental Value Exposure (EVE) according to the present invention.

FIG. 6 is a flow diagram illustrating an example method of applying IHLCA data to produce the future (internalized) cost (i.e., at-risk) component of the Environmental Value Exposure (EVE) according to the present invention.

FIG. 7 is a flow diagram illustrating an example method of applying IHLCA data to produce the total cost of ownership (TCO, which includes the ordinary, hidden, and contingent cost) component of the Environmental Value Exposure (EVE) according to the present invention.

FIG. 8 is a flow diagram illustrating an example method of building a dynamic mitigation library according to the present invention.

FIG. 9 is a flow diagram illustrating an example method of projecting prices and building the future portion of the database of current and future internal costs according to the present invention.

FIG. 10 is a flow diagram illustrating an example method of estimating current internalized prices and building the current portion of the database of current and future internal costs according to the present invention.

FIG. 11 is a flow diagram illustrating an example method of building a dynamic hidden costs library according to the present invention.

FIG. 12 is a screen shot of the environmental flows calculated across the lifecycle of a company using IHLCA according to an embodiment of the present invention.

FIG. 13 is a screen shot of the environmental impacts (external costs) of an organization shown by the tier in the supply chain where the impacts occur and by the item purchased by the organization according to an embodiment of the present invention.

FIG. 14 is a screen shot of the environmental impacts (external costs) of an organization shown by the specific environmental flow causing the environmental impact and by the tier in the supply chain where the impacts occur according to an embodiment of the present invention.

FIG. 15 is a screen shot of the environmental impacts (external costs) of an organization shown by environmental impact endpoints and by the item purchased by the organization according to an embodiment of the present invention.

FIG. 16 is a screen shot of the internal costs of an organization by the tier in the supply chain where the cost occurs and by the environmental flow contributing to the internal costs according to an embodiment of the present invention.

FIG. 17 is a screen shot of the internal costs of an organization by the items purchased by the industry and by the tier in the supply chain where the costs occur according to an embodiment of the present invention.

FIG. 18 is a screen shot of the estimated future costs associated with environmental flows within the supply chain of each industry the organization purchases from according to an embodiment of the present invention.

FIG. 19 is a screen shot of estimated future costs associated with an organization's environmental flows, broken down by the tier in the supply chain where the costs are expected to occur according to an embodiment of the present invention.

FIG. 20 is a screen shot illustrating one case of being able to view impacts in the supply chain, by tier, and by supplier, with the added ability to dynamically explore multiple tiers into the supply chain to explore what activities in the supply chain are contributing to higher level impacts and gain insight into the supply chain from an environmental and a financial perspective according to an embodiment of the present invention.

FIG. 21 illustrates the top 10 purchased items by an organization in terms of spend on each item and the total environmental impact of each item according to an embodiment of the present invention.

FIG. 22 illustrates the contribution of energy costs to the organization's total expenses and total environmental impacts according to an embodiment of the present invention.

FIG. 23 and FIG. 24 illustrate the environmental impacts (external costs) of an organization shown by the specific environmental flow causing the environmental impact and by the tier in the supply chain where the impacts occur according to an embodiment of the present invention.

FIG. 25 illustrates, specifically for energy use, the environmental impacts in each tier of the supply chain, and the direct spend on energy throughout the supply chain according to an embodiment of the present invention.

FIG. 26 illustrates the spend on energy related items (electricity, coal, natural gas, etc.) by an organization and its supply chain as a percentage of the organization's EBITDA according to an embodiment of the present invention.

FIG. 27 illustrates a cost curve for various initiatives (mitigation activities) that an organization could undertake to reduce their environmental impacts according to an embodiment of the present invention.

FIG. 28 illustrates an environmental cost curve for various initiatives (mitigation activities) that an organization could undertake to reduce their environmental impacts according to an embodiment of the present invention.

FIG. 29 illustrates a user generating multiple scenarios of the initiatives (mitigation activities) they might want to implement going forward according to an embodiment of the present invention.

FIG. 30 illustrates a user's view of projected results of implementing various mitigation activities (initiatives) according to an embodiment of the present invention.

FIG. 31 illustrates the environmental impacts and savings opportunities associated with a selected set of product categories according to an embodiment of the present invention.

FIG. 32 is an extension of the page shown in FIG. 31 and illustrates the integrated performance metrics associated with the selected set of product categories according to an embodiment of the present invention.

FIG. 33 illustrates the suppliers who are the best and worst performers both financially and environmentally across all product categories according to an embodiment of the present invention.

FIG. 34 illustrates details on the environmental and financial performance of a particular supplier according to an embodiment of the present invention.

FIG. 35 illustrates a number of mitigation opportunities that could be implemented with various suppliers according to an embodiment of the present invention.

FIG. 36 illustrates a ranking of the top 10 most impacting product categories purchased by the organization according to an embodiment of the present invention.

FIG. 37 illustrates, for a selected product category, the top 10 environmental flows contributing to the environmental impacts of that product category and the potential for mitigating those environmental impacts through mitigation activities such as equipment replacement or retrofits according to an embodiment of the present invention.

FIG. 38 illustrates the ranking of specific products by their environmental impact according to an embodiment of the present invention.

FIG. 39 illustrates, for a specific product, the top 10 environmental flows contributing to the environmental impacts and the potential for mitigating those environmental impacts through mitigation activities such as building controls or leakage reductions according to an embodiment of the present invention.

FIG. 40 presents an overview on how embodiments of the present invention can use company or product data on activities throughout production and to combine and merge with an environmental data to first produce an inventory of environmental flows that are then passed through a characterization database to determine the midpoint and endpoint impacts associated with those environmental flows, which are then assigned an internal, external, and at-risk valuation to obtain the final cost associated with those environmental flows.

FIG. 41 illustrates a comparison of the total cost of ownership both financially and environmentally for two equivalent tank designs according to an embodiment of the present invention.

FIG. 42 illustrates the integration of financials and environmental impact when comparing costs associated with two equivalent products according to an embodiment of the present invention.

FIG. 43 and FIG. 44 show a high-level software architecture for implementing exemplary methods of the present invention according to an exemplary embodiment of the present invention.

FIG. 45 is a sample list of externally created environmental databases useful in providing inputs to various embodiments of the present invention.

FIG. 46 is a diagram showing an exemplary breaking down of environmental impacts into endpoints and midpoints according to an embodiment of the present invention.

### DETAILED DESCRIPTION

Hereinafter, exemplary embodiments of the invention will be described in more detail with reference to the accompanying drawings. In the drawings, like reference numerals refer to like or similar elements throughout. In addition, it should be noted that the term “organization” in these descriptions could mean an organization in a broad sense, but also a product, division, business area, region, service, or other subset of an organization or portion of an organization's financial hierarchy (e.g., plant, department). Likewise, the term “product” could mean a product in the broad sense but also could mean a commodity, while the term “activity” could mean an activity in the broad sense but also could mean a service. Further, the term define “supply chain” can refer to any combination of stages from cradle to grave of an organization including any subset of the plurality of materials extraction, transportation, manufacturing, distribution, retail, use, and end of life stages.

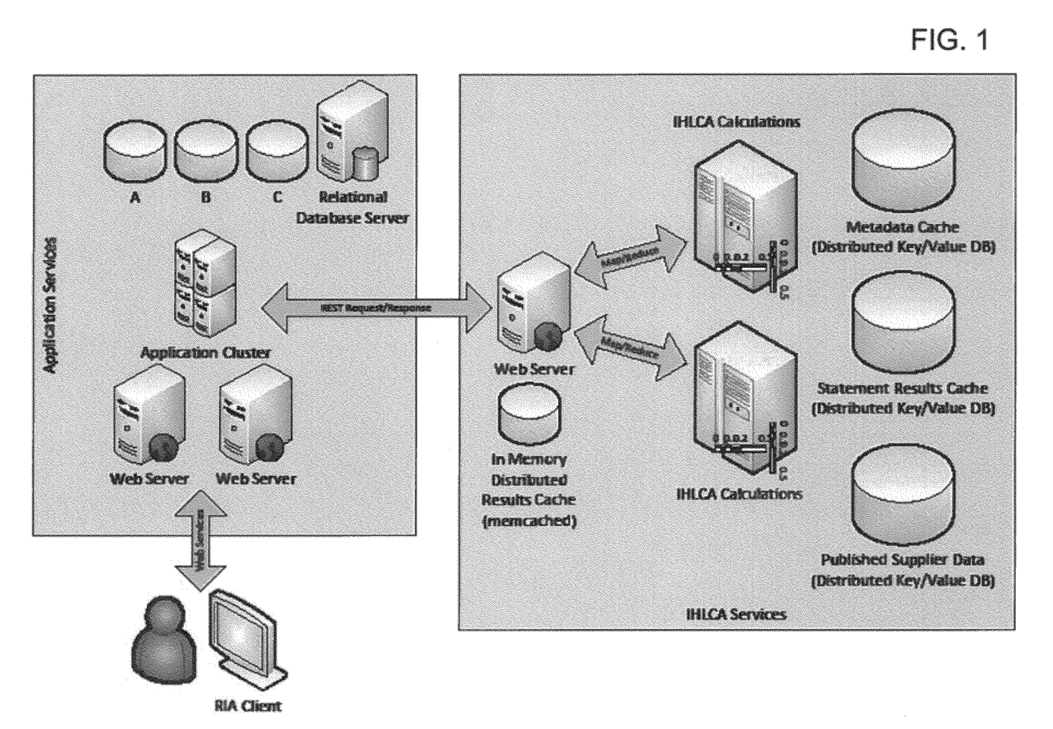

FIG. 1 illustrates a system architecture for implementing exemplary methods of the present invention according to an exemplary embodiment of the present invention. An exemplary system would include: (i) one or more non-volatile storage devices (such as disk drives) for storing, for example, databases constructed and accessed during applications of embodiments of the present invention; and (ii) one or more computing devices (such as servers, client computers, or other automated processing devices including one or more central processing units (CPUs) and memory, together with software including machine instructions, the machine instructions to execute on the CPUs to perform exemplary methods of the present invention). Additional features of the system can include network connections to connect to an internal or external network (for example, the Internet). In addition, the system may be cloud-based to make the tools, databases, and interfaces of the system dynamically updated and readily available to all parts of the world.

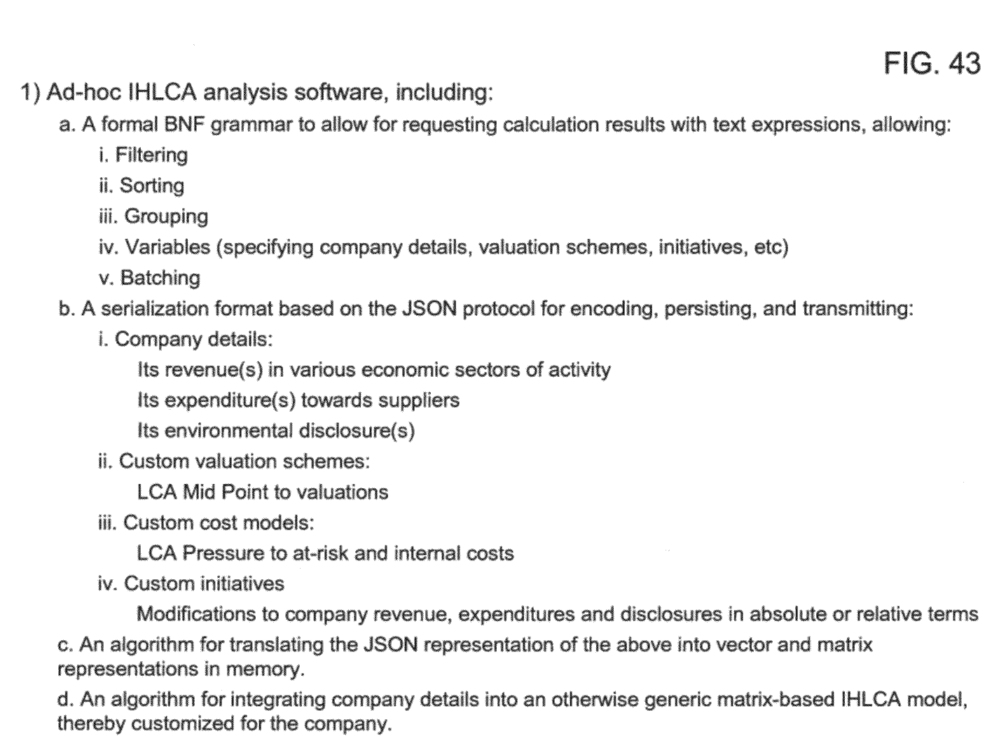

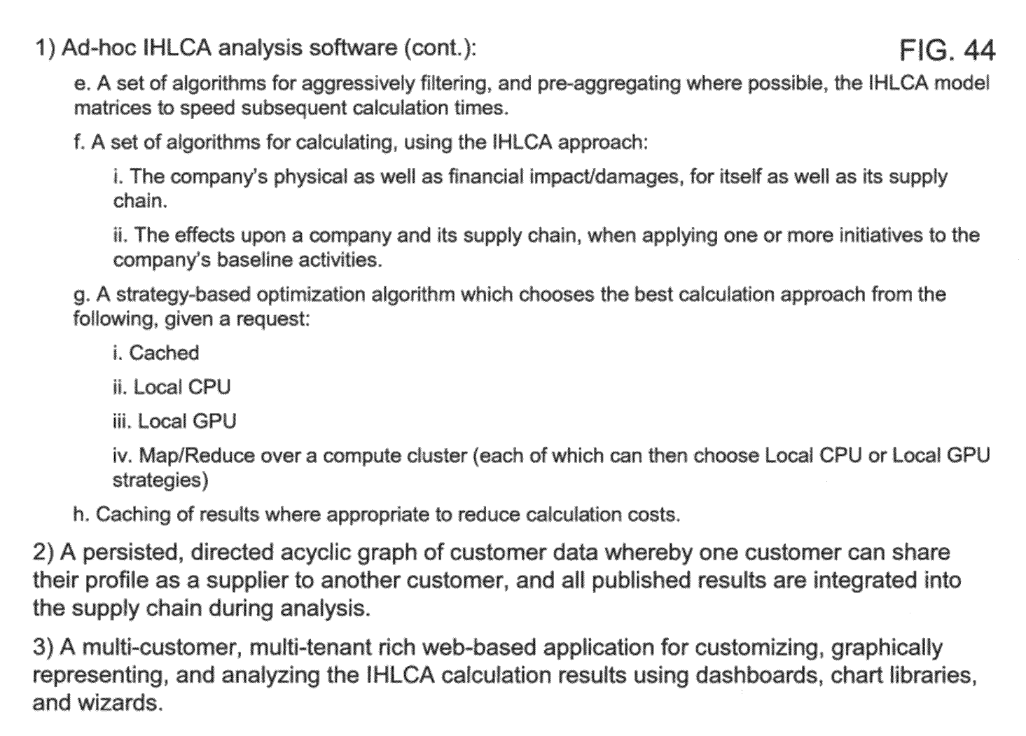

FIG. 43 and FIG. 44 show a high-level software architecture for implementing exemplary methods of the present invention according to an exemplary embodiment of the present invention. FIG. 43 and FIG. 44 list, in outline form, the major software components of an exemplary embodiment of the present invention to allow one of ordinary skill in the art the ability to implement, in software, embodiments of the present invention as described in (or apparent to one of ordinary skill from) this disclosure.

### Exemplary Methods

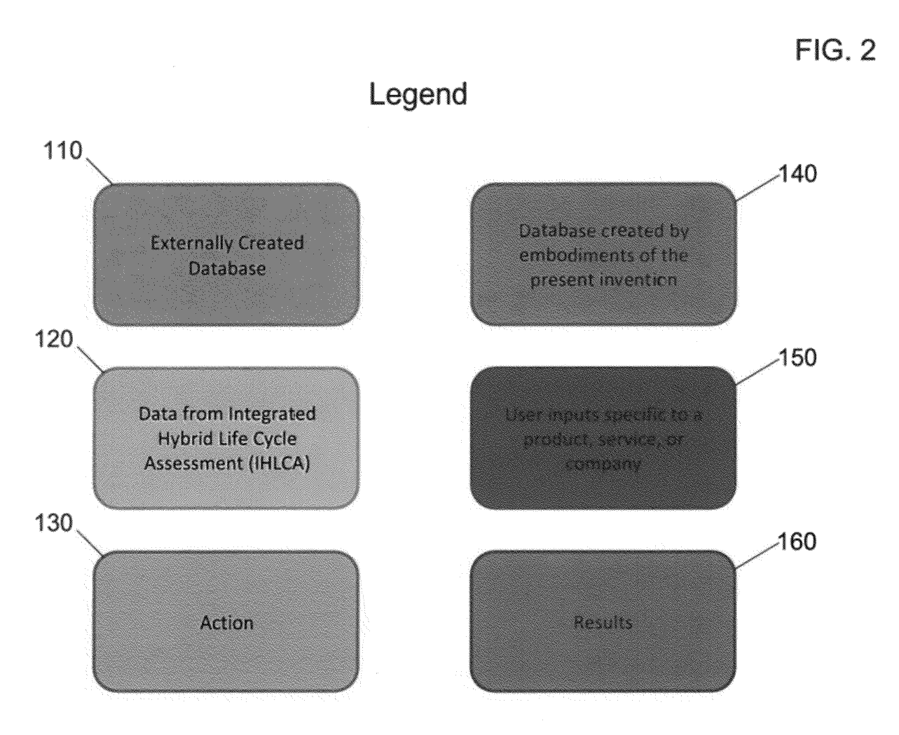

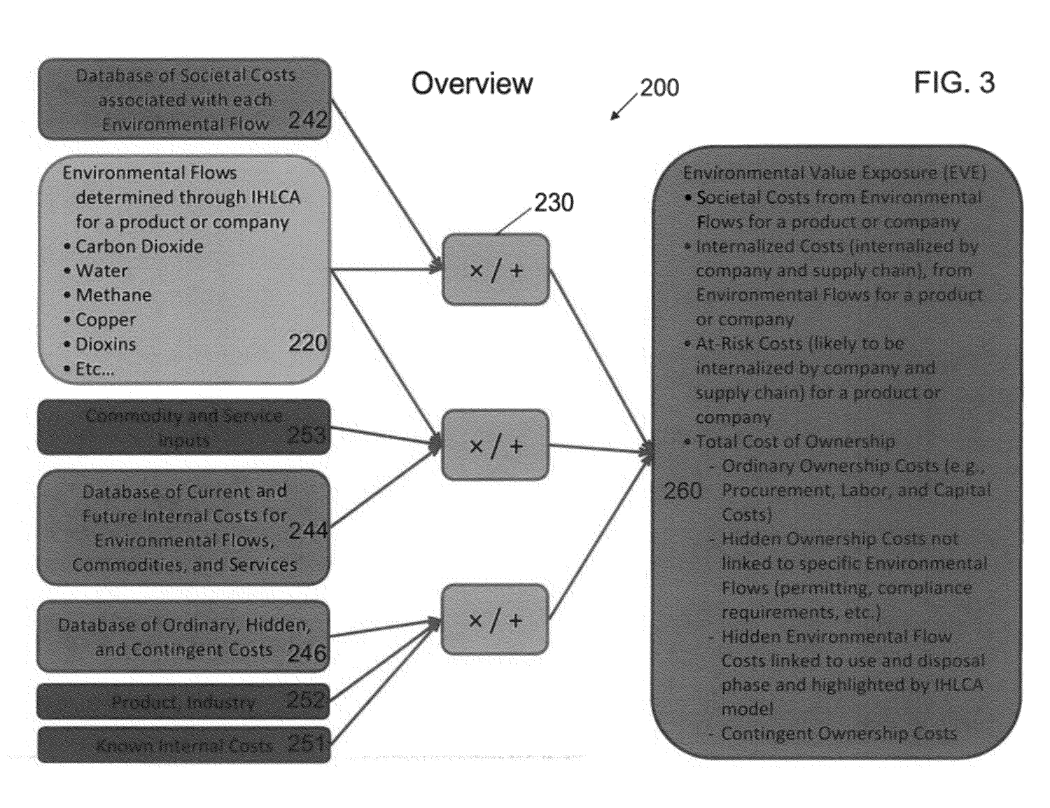

FIG. 3 through FIG. 11 illustrate different exemplary methods of the present invention suitable for automated (or partially automated) implementation on, for example, the system of FIG. 1. FIG. 2 is a legend of the different colored text boxes used in FIG. 3 through FIG. 11.

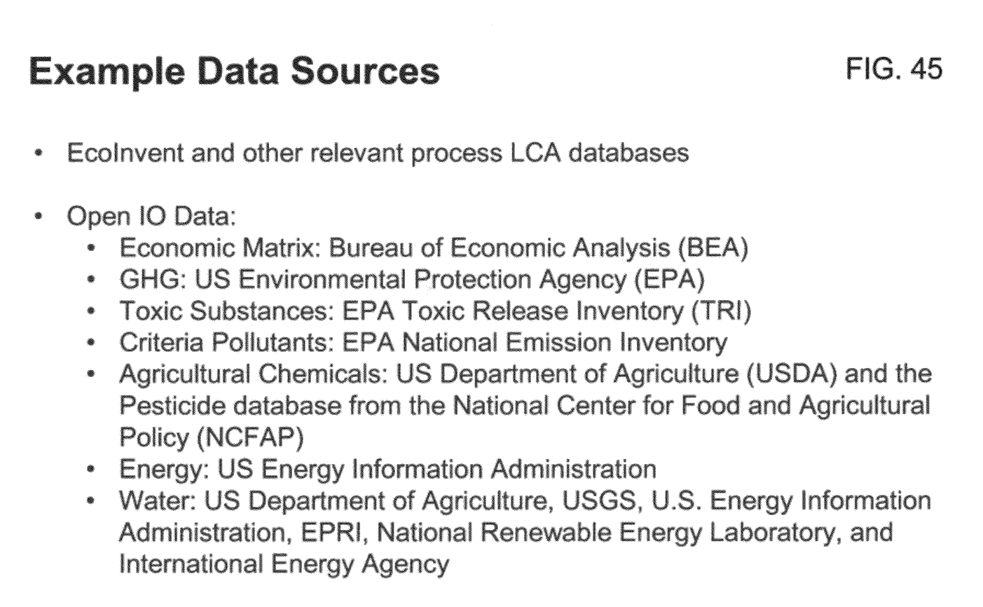

Referring to FIG. 2, orange boxes 110 (and having reference numerals with a ten's digit of ‘1’) denote externally created databases, such as those listed in FIG. 45, that are useful for providing input data in various embodiments of the present invention. Gray boxes 120 (and having reference numerals with a ten's digit of ‘2’) denote data obtained from Integrated Hybrid Life Cycle Assessment (IHLCA) analysis, such as environmental flows (e.g., land use, raw material consumption, water consumption, and pollutant releases to air, land, and water). Green boxes 130 (and having reference numerals with a ten's digit of ‘3’) denote action steps, such as calculations (e.g., multiplication and addition) or decisions (e.g., implement option A or option B).

In addition, red boxes 140 (and having reference numerals with a ten's digit of ‘4’) denote specially created databases, such as from embodiments of the present invention (e.g., database of ordinary, hidden, and contingent costs). Blue boxes 150 (and having reference numerals with a ten's digit of ‘5’) denote user supplied inputs specific to an organization (e.g., product, service, or company), such as the user's current internal costs with each specific environmental flow. Some of this processing may be manual as it can involve, for example, compiling data from many sources, depending on the environmental flow. Lastly, purple boxes 160 (and having reference numerals with a ten's digit of ‘6’) represent results, that is, outputs of various embodiments of the present invention, such as total cost of ownership (broken down by areas such as ordinary (e.g., procurement) costs, hidden costs, and contingent costs).

FIG. 3 is a flow diagram illustrating an overview of exemplary methods 200 according to the present invention.

Referring to FIG. 3, the methods 200 have various inputs, including IHLCA data (environmental flows) 220, special databases (such as societal costs 242, current and future internal costs 244, and ordinary, hidden, and contingent costs 246 associated with each environmental flow), and user-supplied data (such as a particular product or industry 252). By combining the data in different combinations using operations 230 (such as multiplication and addition), useful outputs, such as environmental value exposure (EVE) 260, associated with the particular product or industry are generated. It should be noted that the special databases could be combined or split up (e.g., current and future prices 244 can be one database or separate databases for current prices and future prices) in other embodiments of the present invention as would be apparent to one of ordinary skill in the art.

These EVE outputs 260 can include exposed environmental costs, for example, societal costs (that is, externalized costs paid by society and not by the company), internalized costs (e.g., paid by the company), at-risk costs (e.g., future regulatory measures, price increases), and total cost of ownership (TCO, which includes ordinary (e.g., procurement) costs, hidden costs, and contingent costs), or an aggregation of the exposed costs, such as a sum of the societal costs, internalized costs, at-risk costs, and TCO, which is hereinafter referred to as the environmental value exposure (EVE) score. The EVE refers to the totality of all the costs being exposed in the system, and provides a measure for sustainability for the organization. The information is presented in forms upon which business leaders can make informed decisions (for example, dollars), as shown in more detail later.

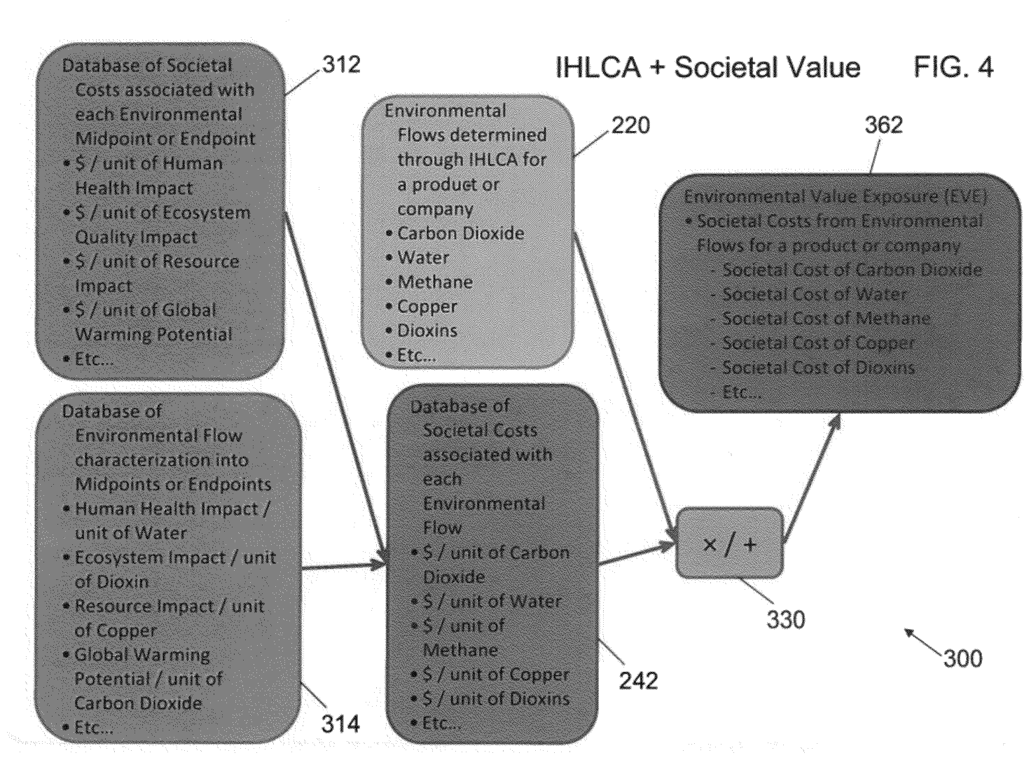

In addition, each of the costs can be calculated by an organization's financial hierarchy (e.g., division, region, plant, product, department) to understand areas of importance and risk within the organization. Similarly, these costs can be calculated for suppliers and purchased goods. The merger of environmental and financial costs, then, enables tradeoffs and efficient/effective decision making within an organization and across its customers and suppliers. Example methods will now be presented with reference to FIG. 4 through FIG. 7.

FIG. 4 is a flow diagram illustrating an example method 300 of applying Integrated Hybrid Life Cycle Assessment (IHLCA) data to produce the societal (externalized) cost component of the Environmental Value Exposure (EVE) according to the present invention.

Referring to FIG. 4, IHLCA is used to generate the environmental flows 220. There are a multitude of environmental flows representing each of the different pollutants, greenhouse gases (GHG), scarce resources, and other environmental factors or components that has an impact on the environment. Examples include carbon dioxide and methane (greenhouse gases), fresh water, copper (a mineral), dioxins (a pollutant), etc. Using IHLCA, these environmental flows 220 can be determined for an organization (company, product, etc.). For instance, IHLCA can be used to determine that the manufacture of a particular screwdriver results in the production of 20 pounds of carbon dioxide, a greenhouse gas (GHG).

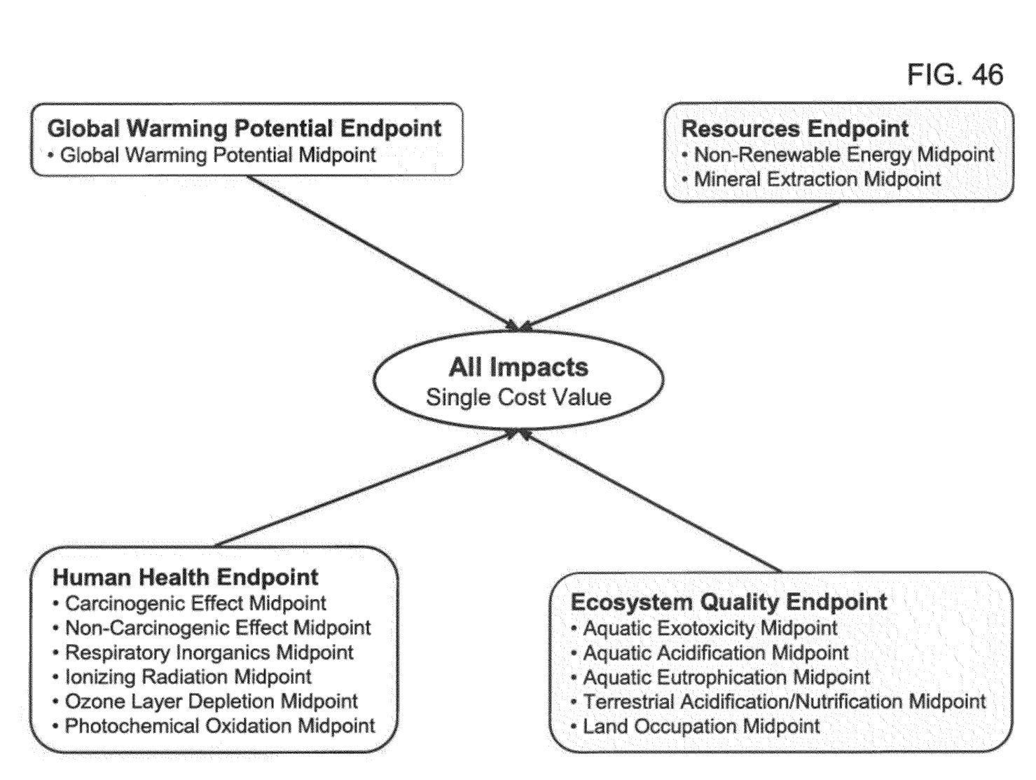

As the number of environmental flows is far too great (for example, some methodologies track over 2200 separate environmental flows) to be able to make informed tradeoffs of one flow for another, the effects of such flows have been characterized into a set of midpoints (roughly 10-20 depending on the model). For instance, in an exemplary model according to the present invention, 14 separate midpoints are identified, as illustrated in FIG. 46, and include such midpoints as global warming potential (GWP), carcinogenic effect, land occupation, and mineral extraction. These midpoints, in turn, are aggregated into 3-4 endpoints depending on the model (e.g., the exemplary model in FIG. 46 has four endpoints: global warming potential (GWP), human health, ecosystem quality, and resources).

The endpoints, in turn, can be further combined into a single point, for example, a single cost value point. Scientific uncertainty is introduced at each stage of aggregation from environmental flows, to midpoints, to endpoints, and finally to a single cost value. However, each level of aggregation makes the results easier for someone to weigh tradeoffs between disparate environmental flows and make informed business decisions. The method 300 of FIG. 4 is a way of performing this valuation in terms of societal costs, providing an ability to articulate in monetary terms each of a product's external impacts to the environment (and not paid by the organization) that have been identified.

Continuing with FIG. 4, in addition to the specific environmental flows 220 of interest, a more general-purpose database 242 is constructed that maps the societal costs associated with each environmental flow. One way to construct such a database 242 is to use publicly available external databases, such as database 312 that provides the societal costs associated with each environmental midpoint or endpoint (e.g., so many $ per unit of GWP), and database 314 that characterizes each of the environmental flows into their constituent impacts of each midpoint or endpoint (e.g., so much GWP for each ton of carbon dioxide generated). Databases 312 and 314 can be combined to produce the database 242 of the societal costs associated with each environmental flow (e.g., $ per ton of carbon dioxide generated).

Finally, the societal cost component 362 of the Environmental Value Exposure (EVE) for a particular organization can be determined by performing calculations 330 (for example, multiplication and addition) of the specific environmental flows 220 associated with the organization and the individual societal costs 242 associated with each flow. These costs 362 can be broken down by individual environmental flow, or aggregated by midpoint, endpoint, or even as a single value. Method 300 thus takes seemingly disparate environmental flow data 220 and converts it into cost data 362 that businesses can use to make educated choices on how to affect the environment.

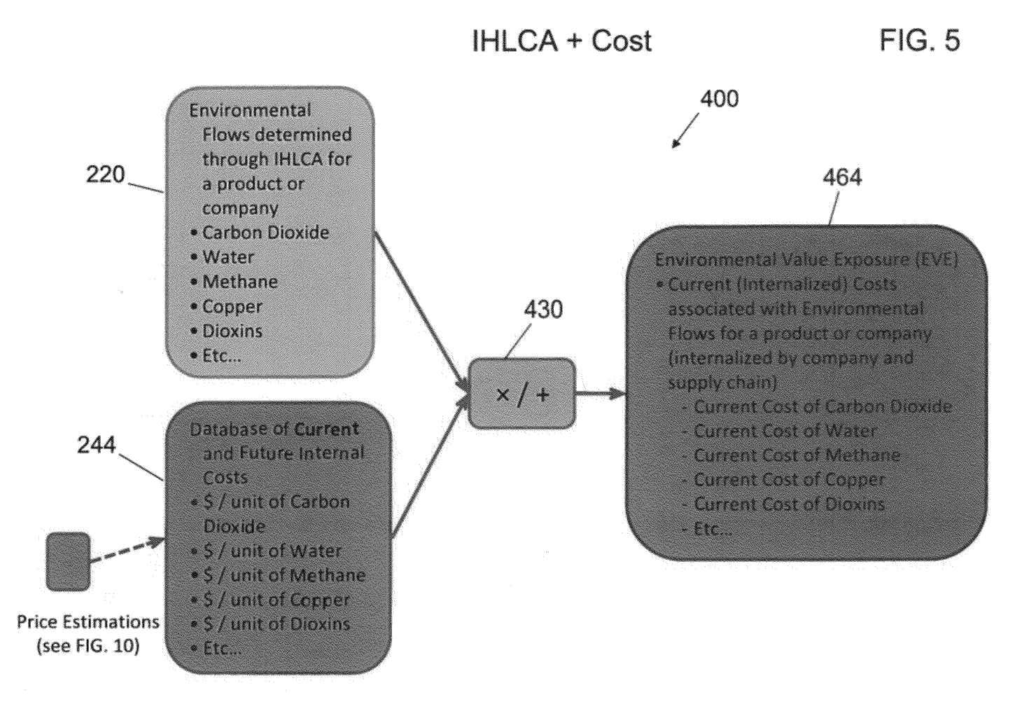

FIG. 5 is a flow diagram illustrating an example method 400 of applying IHLCA data to produce the current (internalized) cost component of the Environmental Value Exposure (EVE) according to the present invention.

Referring to FIG. 5, while the method 300 in FIG. 4 provided a way to produce the societal (externalized) cost component of EVE to businesses of the environmental impact of their products or activities, there are other costs that are important (if not more important) to businesses, such as the internalized costs (that is, paid by the business) associated with each environmental flow. For instance, businesses may be taxed based on their production of certain pollutants (such as carbon dioxide), or may have to pay for equipment of services to reduce their emissions of certain pollutants to “safe” levels. To a business, these represent current internalized (or internal) costs that affect a business' bottom line just like any other expense. Method 400 thus provides a way to estimate these costs 464 for a particular organization (e.g., product, company) of interest.

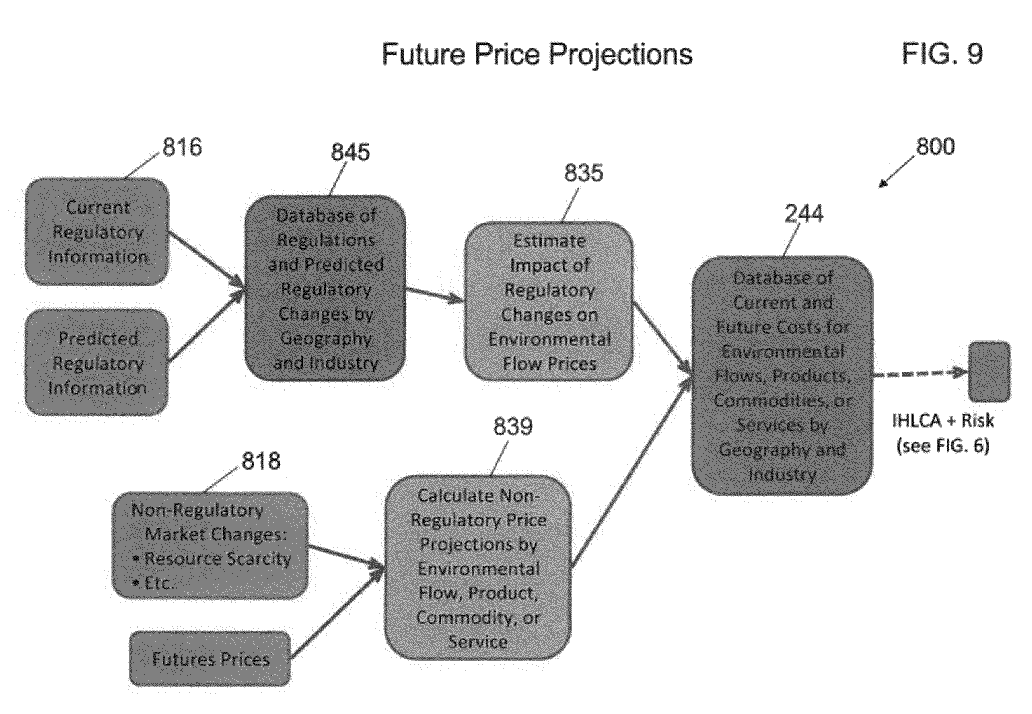

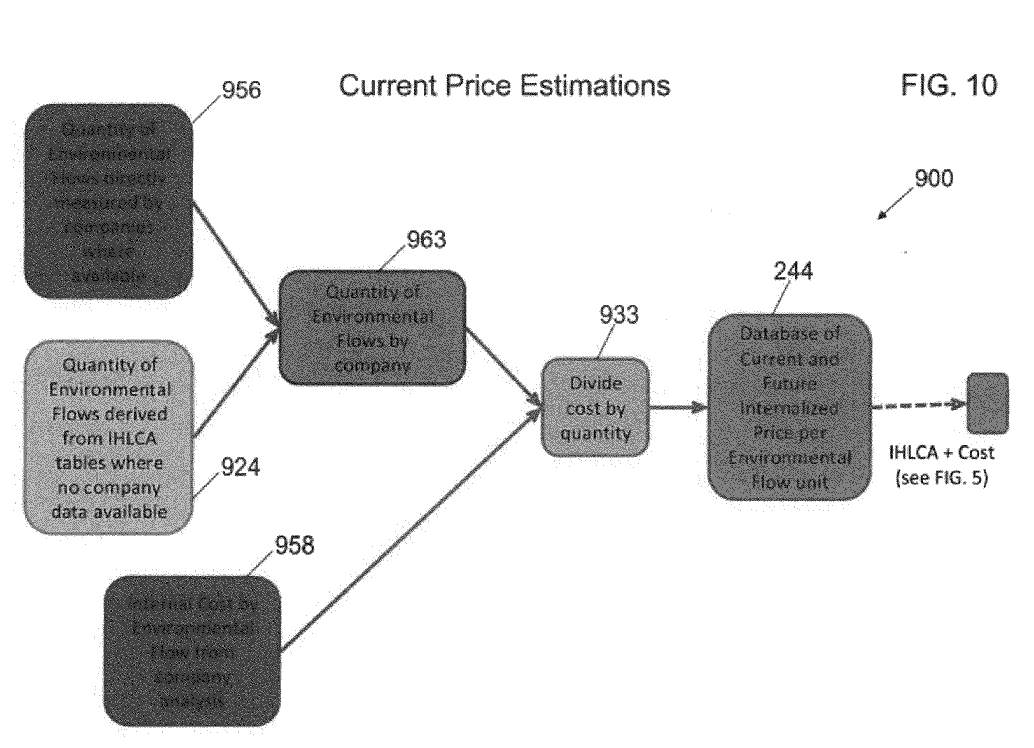

IHLCA data of the environmental flows 220 is determined for the organization in manner similar to that of environmental flow data 220 of method 300. This is combined with a specially constructed database 244 of current and projected future internal costs associated with each environmental flow and purchased commodities or services. The construction of the database 244 is discussed in FIG. 9 and FIG. 10 below (with FIG. 10 describing the portion relevant to current internal costs). Using similar calculations 430 to those of method 300, the environmental flow data 220 is combined with the current portion of the current and future internal costs database 244 to produce the current (internalized) cost component 464 of the Environmental Value Exposure (EVE) associated with each environmental flow for the particular organization of interest. This current cost data 464, like the societal cost data 362 of method 300, can in turn be aggregated by midpoint, endpoint, or consolidated into a single value to allow business leaders to make appropriate tradeoffs considering present day internalized environmental impact costs.

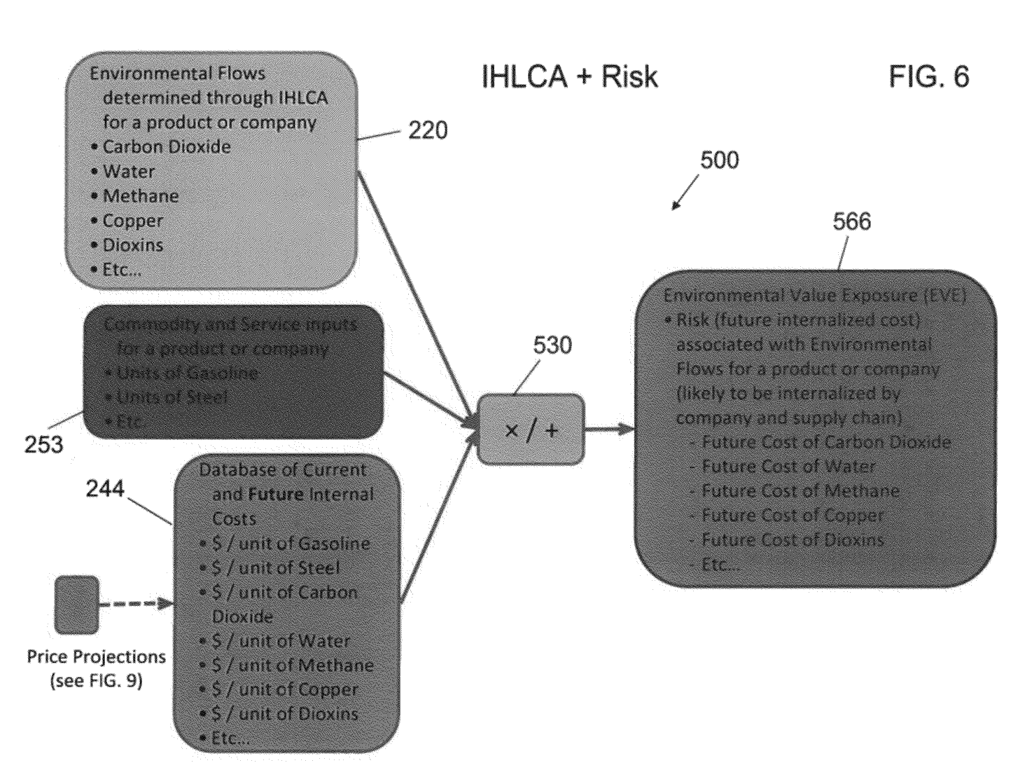

FIG. 6 is a flow diagram illustrating an example method 500 of applying IHLCA data to produce the future (internalized) cost (i.e., at-risk) component of the Environmental Value Exposure (EVE) according to the present invention.

Referring to FIG. 6, as with methods 300 and 400 in FIG. 4 and FIG. 5, which provided ways to produce the societal (external) and current (internal) cost components of EVE to businesses of the environmental impact of their products or activities, another important cost to businesses is the future risk (i.e., projected) internalized costs associated with each environmental flow and the future risk (i.e., projected) internalized costs associated with various purchased commodities and services. For instance, carbon dioxide may soon be regulated through carbon credits, or scarce resources may be projected to significantly increase in cost in the near future. To a business, these represent at-risk (or future) internal costs whose long-term impact is every bit as important as the current internal costs. Additionally, the price of gasoline may be expected to increase in the future due to scarcity or conflict. Method 500 thus provides a way to estimate these costs 566 for a particular organization (e.g., product, company) of interest.

As with methods 300 and 400, IHLCA data of the environmental flows 220 is determined for the organization. Additionally, commodity and service inputs 253 required for the organization are provided. These two datasets are combined with the specially constructed database 244 of current and projected future internal costs, as with method 400 above, only using the future portion of the current and future internal costs database 244. The construction of this portion of the current and future internal costs database 244 is discussed in FIG. 9 below. Using similar calculations 530 to those of method 400, the environmental flow data 220 and input data 253 are combined with the future portion of the current and future internal costs database 244 to produce the future internal (i.e., at-risk) cost component 566 of the Environmental Value Exposure (EVE) associated with each environmental flow for the particular organization of interest. This at-risk cost data 566, like the societal cost data 362 of method 300 and the current internal cost data 464 of method 400, can in turn be aggregated by midpoint, endpoint, or consolidated into a single value to allow business leaders to make appropriate tradeoffs considering possible or likely future environmental impact factors.

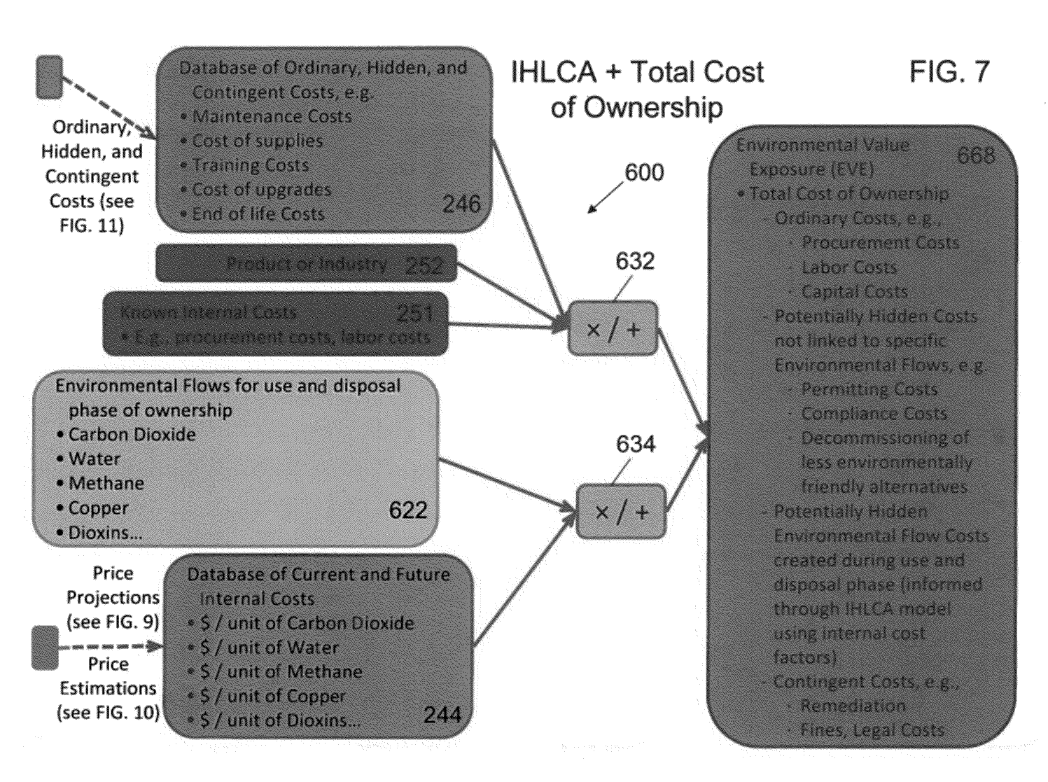

FIG. 7 is a flow diagram illustrating an example method 600 of applying IHLCA data to produce the total cost of ownership (TCO, which includes the ordinary, hidden, and contingent cost) component of the Environmental Value Exposure (EVE) according to the present invention.

Referring to FIG. 7, as with methods 300, 400, and 500 above, there are still more environmental impact costs that an organization may be concerned with, and that can be exposed, such as the total cost of ownership (TCO) 668. The TCO 668 refers to all the ordinary costs, as well as potentially hidden costs and contingent costs, that an organization is responsible for because of its particular product or industry, in addition to corresponding environmental flow costs for a product or industry encountered during the use and disposal phase of ownership (such as gas to power equipment, or disposal costs related to retiring the equipment). These represent the bottom line costs that an organization is spending currently on environmental impacts not directly attributable to specific environmental flows, as well as to impacts related to the use and disposal phase of ownership that are attributable to specific environmental flows.

Many business leaders would consider the TOC 668 to be important as it affects bottom-line business performance. These costs 668 can include, for instance, ordinary costs (such as procurement costs, labor costs, and capital costs), potentially hidden costs not linked to specific environmental flows (such as permitting costs, regulatory compliance costs, and costs associated with decommissioning less environmentally friendly alternatives), and contingent costs (such as remediation costs as well as fines and legal costs). These costs 668 can also include the potentially hidden environmental flow costs encountered during the use and disposal phase of ownership.

Method 600 can be used to calculate the TCO 668 by using several inputs, including the ordinary, hidden, and contingent costs 246 as applied to a specific product or industry 252 of interest, the environmental flow data 622 for a company or product for the use and disposal phase of ownership (similar to the IHLCA data 220 used in methods 300, 400, and 500 above) and the current and future internal cost costs 244, as well as the known costs 251 (that is, ownership costs already known to the organization, such as procurement costs and labor costs).

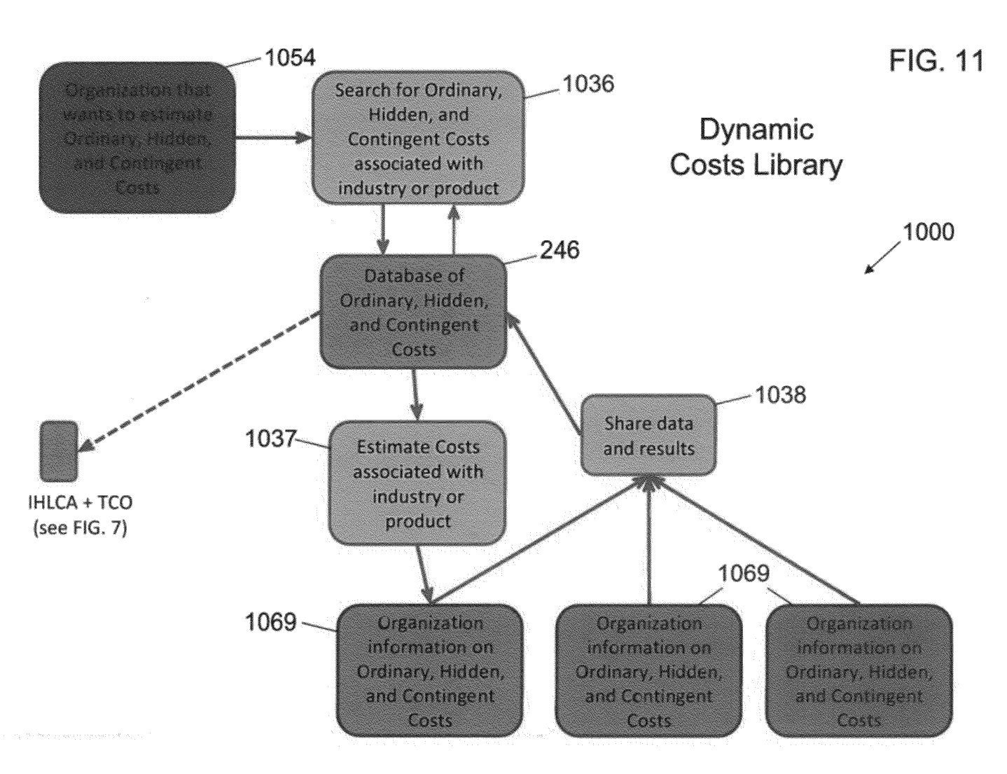

Much of the internalized costs of managing environmental flows are hidden or contingent type costs, which can be difficult to identify or quantify. Nonetheless, since the organization is responsible for paying these costs, they do add to the total cost of ownership 668 component of EVE and should be accounted for. To this end, and as described further in FIG. 11 below, a specially constructed database 246 of ordinary, hidden, and contingent environmental impact costs associated with different product types and industries is provided.

These ordinary, hidden, and contingent costs include not only ordinary costs (such as procurement, labor, and capital costs), but also not so apparent factors such as maintenance, supplies, training, upgrades, and disposal (end of life) that can be attributed to the management of a specific product or industry. These ordinary, hidden, and contingent costs are tracked by product or industry. For example, within a particular industry (automobile manufacturing) there could be hidden costs associated with training people how to use environmental safety equipment associated with particulate releases during the painting phase. By combining the specific product or industry 252 with the database 246 of ordinary, hidden, and contingent costs, and doing calculations 632 (e.g., multiplication and addition), accurate assessments of the ordinary, hidden, and contingent costs can be obtained and used to estimate for total cost of ownership 668.

In addition, the TOC component 668 also includes potentially hidden environmental flow costs created during the use and disposal phase of ownership, and can be accounted for through the IHLCA model data using the internal cost factors used to compute the current and future internalized cost components in methods 400 and 500. The current and future internal cost data 244 can be specific to a company or organization, and reflects that company's or organization's apparent or direct internal costs (current and future) for specific environmental flows (such as costs of compliance or reporting, carbon credit costs to emit carbon dioxide, or purchasing costs of scarce resources). By combining the current and future internal cost data 244 with the organization's environmental flow data 622 through calculations 634 (e.g., multiplication and addition), the internal environmental costs associated with the particular organization (for example, product or department) can be determined.

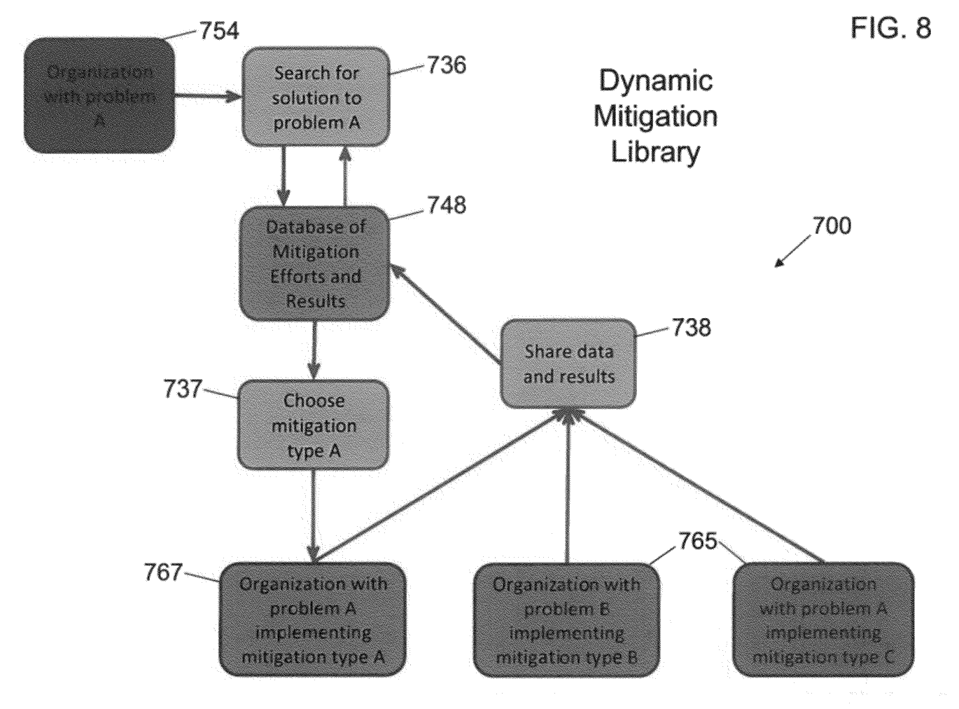

FIG. 8 is a flow diagram illustrating an example method 700 of building a dynamic mitigation library 748 according to the present invention.

Methods 300, 400, 500, and 600 provide ways for businesses to determine costs for environmental impacts, be it external (societal costs, method 300), current internal (method 400), at-risk (future costs, method 500), or total cost of ownership (TCO, method 600), or even a combination of all four (Environmental Value Exposure, or EVE). Sometimes businesses want to do the next step: take some action to reduce or eliminate (i.e., mitigate) a problem (environmental impact). While methods 300, 400, 500, and 600 can estimate how much can be saved if an environmental impact is mitigated, equally important to a business is how much it will cost to implement this mitigation. In addition, there may be several possible mitigation options (types); how would a business know which one to implement? Method 700 can provide businesses with the ability to make informed decisions regarding mitigation plans.

Referring to FIG. 8, in box 754, suppose an organization has an environmental problem A that it may be interested in solving or mitigating. According to method 700, the organization searches 736 for a solution to problem A or for opportunities within their industry or product category, which includes looking through database 748 of mitigation efforts and results for appropriate mitigation types and possible costs and results. Upon finding 737 an appropriate plan, say mitigation type A, the organization implements 767 mitigation type A to solve problem A.

Mitigation plans are conducted all the time by real companies. Often such choices are based on engineering studies of potential costs and benefits, which are produced with various assumptions (such as aged or averaged data) and may not be reflective of what a company really experiences if they implement the plan. Method 700 captures the real world implementation data by sharing 738 the various mitigation efforts and results of different organizations. This allows organizations to collaborate using a shared database and to understand mitigation opportunities to solve their particular environmental problem, or to understand mitigation opportunities that are specific to their industry or product.

For example, while the above organization implemented 767 mitigation type A to solve problem A, other organizations implement 765 their own mitigation plans to address the same or different problems. All of these companies generate real data and results based on their experiences. Step 738 captures this real world data and puts it into database 748 to keep the database 748 current and accurate (i.e., evergreen, or refined from use). Database 748 is thus a dynamic mitigation library 748 that can be shared with other organizations facing similar tradeoff choices to allow those organizations to make informed decisions on which mitigation options are most appropriate for them. The dynamic mitigation library 748 could be, for example, cloud-based to keep it easily accessible and maintainable to any organization.

FIG. 9 is a flow diagram illustrating an example method 800 of projecting prices and building the future portion of the database 244 of current and future internal costs according to the present invention.

Referring to FIG. 9, method 800 provides for an automated price projection tool for what is now handled manually and less efficiently. Method 800 translates information on regulations 816 (for example, regulatory databases containing current regulatory information and predicted (future) regulatory information) and information on non-regulatory market changes 818 (for example, resource scarcity) into price projections 244 for environmental flows, commodities, and services. As an intermediate step, method 800 creates a database 845 that highlights and synthesizes information on current and future regulations by geography and industry from the different regulatory databases 816. This information is then used to estimate 835 the impact of the regulatory changes on environmental flow prices and translated into an at-risk price associated with environmental flows for inclusion into the future portion of the database 244 of current and future internal costs for environmental flows.

Method 800 also highlights and synthesizes information 818 on futures markets and predicted non-regulatory market changes affecting future prices such as resource scarcity. This information is then used to calculate 839 an at-risk price associated with environmental flows, commodities, and services for inclusion into database 244. This database 244 of current and projected future internal costs associated with each environmental flow enables understanding of what regulatory and non-regulatory changes will affect an organization's current and future costs. The database 244 is also a fundamental component of method 500 for assessing future environmental risk for an organization, as described above.

FIG. 10 is a flow diagram illustrating an example method 900 of estimating current internalized prices and building the current portion of the database 244 of current and future internal costs according to the present invention.

Referring to FIG. 10, in method 900, a company or other organization determines 963 (for example, measures, estimates, models) each of its environmental flows. This can be done in several ways. For example, the company can measure 956 the environmental flow directly. This is appropriate for such environmental flows that are conducive to direct measurement. For those environmental flows that might be too impractical to measure directly, the company can estimate 924 such environmental flows using data derived from IHLCA tables. Further, the company can use both techniques on the same environmental flow, measuring those portions of the environmental flow that are conducive to direct measurement, and modeling or estimating through IHLCA data those portions of the environmental flow that are not conducive to direct measurement. The result is a set of environmental flow quantities 963 that represent the company's environmental footprint as quantified by each of the environmental flows.

In addition, the company also performs its own analysis 958 to account for internal costs that can be attributed to any of the environmental flows. These internalized costs should be those that can be attributed to specific environmental flows (for example, the purchase of carbon credits). Environmental impact costs that are directed towards products or industries, and thus may represent an assortment of environmental flows, are better tracked in the total cost of ownership (TCO) as detailed in method 600 above.

After obtaining the quantities 963 of the respective environmental flows as well as the internal costs 958, calculations 933 (such as dividing the costs by their respective quantities) are performed to produce the current internal cost portion of the database 244 of current and future internalized prices for each unit of the environmental flows.

FIG. 11 is a flow diagram illustrating an example method 1000 of building a dynamic hidden costs library 246 according to the present invention.

Referring to FIG. 11, method 1000 is similar to method 700 used to build the dynamic mitigation library 748. In box 1054, an organization wants to estimate ordinary, hidden, and contingent environmental costs. The organization searches 1036 for ordinary, hidden, and contingent costs associated with the particular industry or product. This searching includes looking up the database of ordinary, hidden, and contingent costs 246 for similar information of other or related organizations that have assessed or estimated such costs for the same industry or product. This results 1037 in an estimated cost for a particular industry or product, which can be combined with actual use data to produce the organization's information 1069 (estimated and actual cost) on ordinary, hidden, and contingent costs. For example, the cost of maintenance, supplies, training, upgrades, and disposal for a particular industry or product can be tracked over time to produce real data.

In similar fashion, other organizations produce similar sets of information 1069 from their studies and actual results, all of which can be shared 1038 and captured in the dynamic hidden costs library 246. As was the case with the dynamic mitigation library 748 in method 700, the dynamic hidden costs library 246 builds from the experience of numerous, and often large, companies who have gone beyond typical cost estimations to uncover hidden and contingent costs related to the use of a product (e.g. regulatory costs from environmental impacts, installation costs, permitting costs, auditing costs, training costs, and remediation costs) and measure actual expenses related to these estimates.

Thus, the dynamic hidden costs library 246 becomes an accurate and evergreen repository of such information for other organizations to use and augment. The dynamic hidden costs library 246 can also be cloud-based to keep it easily accessible and maintainable to any organization. In addition, the dynamic hidden costs library 246 is also a fundamental component of method 600 for estimating the ordinary, hidden, and contingent cost component of the total cost of ownership (all internal costs) of an environmental impact for an organization.

### Exemplary Screen Shots

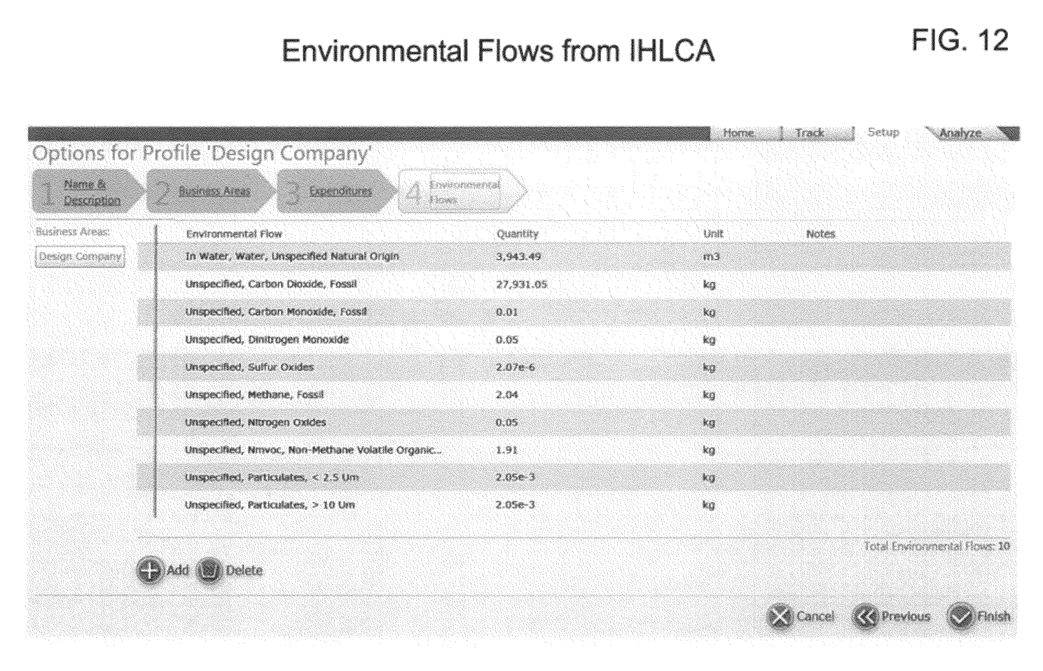

FIG. 12 through FIG. 39 are exemplary screen shots of embodiments of the present invention.

FIG. 12 is a screen shot of the environmental flows calculated across the lifecycle of an organization using Integrated Hybrid Life Cycle Assessment (IHLCA) according to an embodiment of the present invention. This list of environmental flows represents a subset of the total number of environmental flows. In this screen, the user can manually modify the calculated environmental flow quantities and add environmental flows to their results.

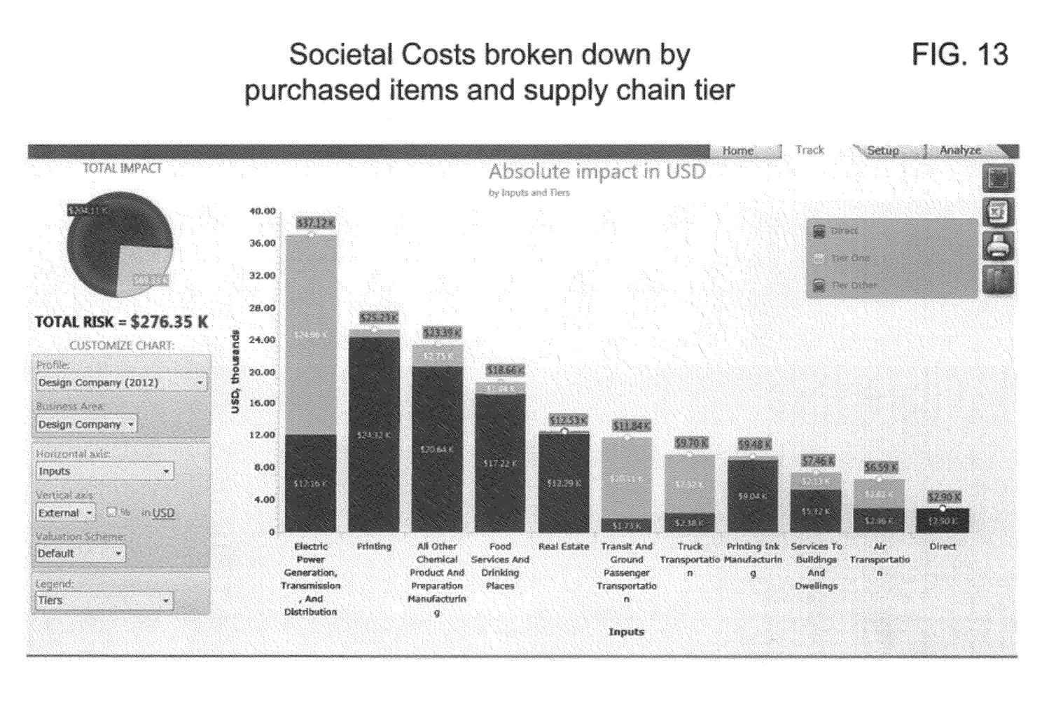

FIG. 13 is a screen shot of the environmental impacts (external costs) of an organization shown by the tier in the supply chain where the impacts occur and by the item purchased by the organization according to an embodiment of the present invention. In this example, the highest impact comes from electricity purchased by the organization. The majority of the impact associated with their electricity purchases comes from the first tier of the supply chain, where the electricity provider is likely burning coal and natural gas. The remainder of the impact associated with their electricity purchases comes from beyond the first tier electricity provider from things like coal mining, transportation, and natural gas pipelines. Furthermore, the pie chart in the upper left of the screen shot shows that the majority of impacts come from beyond the 1st tier suppliers. This view of an organization's results is useful to identify suppliers of interest and develop a strategy for supply chain engagement and impact mitigation.

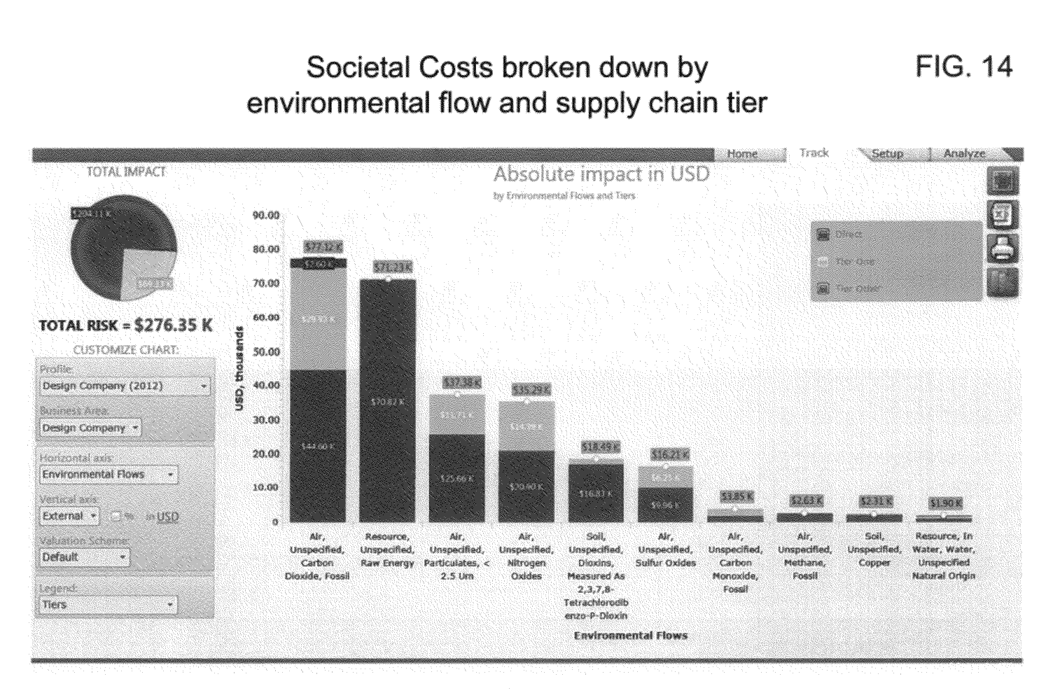

FIG. 14 is a screen shot of the environmental impacts (external costs) of an organization shown by the specific environmental flow causing the environmental impact and by the tier in the supply chain where the impacts occur according to an embodiment of the present invention. In this example, carbon dioxide from fossil fuel combustion is the biggest contributor to environmental impacts with a small opportunity for reduction from carbon dioxide reductions within the organization and a big opportunity to work with 1st tier suppliers on carbon dioxide mitigation through new technologies and efficiency.

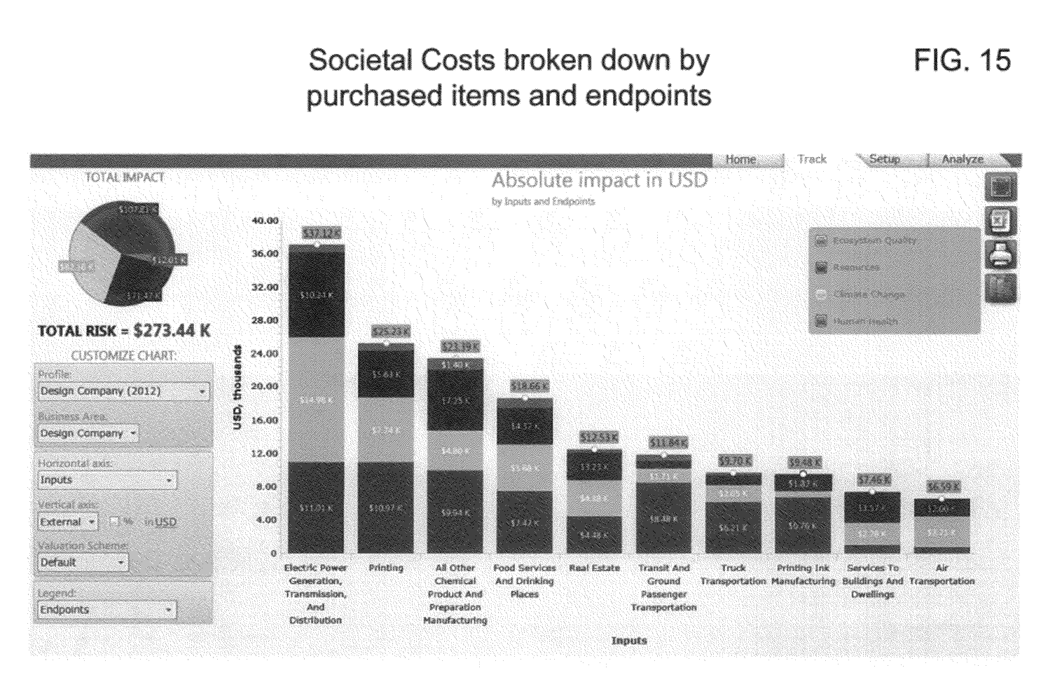

FIG. 15 is a screen shot of the environmental impacts (external costs) of an organization shown by environmental impact endpoints and by the item purchased by the organization according to an embodiment of the present invention. Endpoints represent a way to merge hundreds of environmental flows into three or four distinct impact areas. In this example, there are four endpoints: ecosystem quality, resource impact, climate change, and human health impact. For example, the human health endpoint represents the societal costs associated with illness and death from harmful releases to the environment.

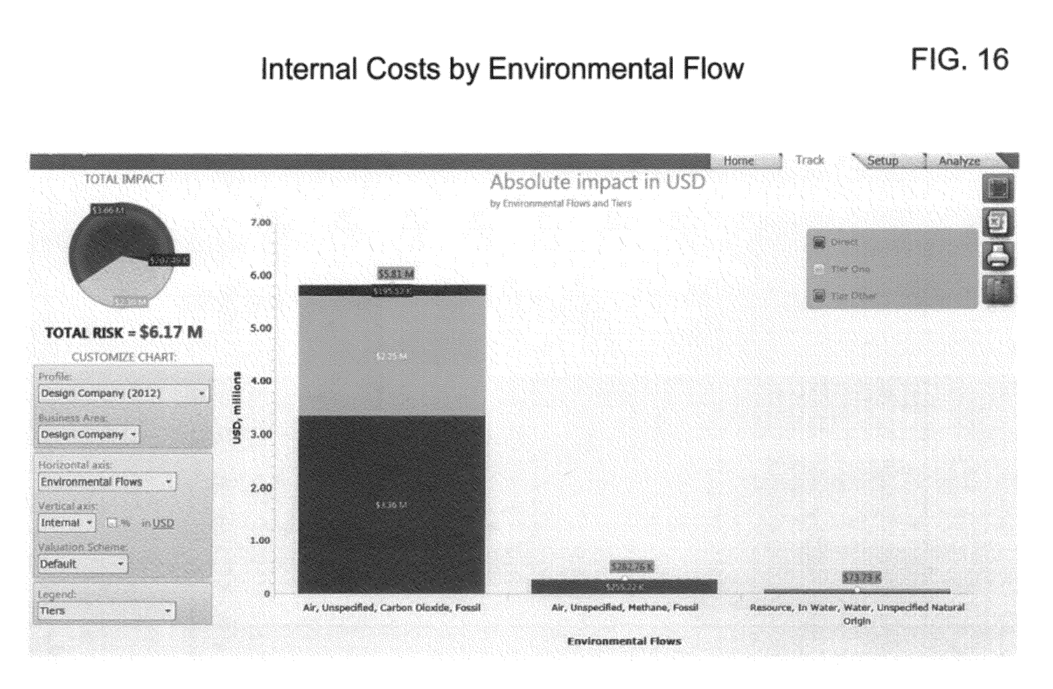

FIG. 16 is a screen shot of the internal costs of an organization by the tier in the supply chain where the cost occurs and by the environmental flow contributing to the internal costs according to an embodiment of the present invention. In this example, only three environmental flows have been assigned an internal cost associated with regulatory compliance and reporting. Direct costs represent the costs directly incurred by the organization associated with their releases of carbon dioxide, methane, and use of water. The tier one and tier other costs represents the costs incurred by suppliers to the organization that may be impacting the organization's procurement costs from those suppliers.

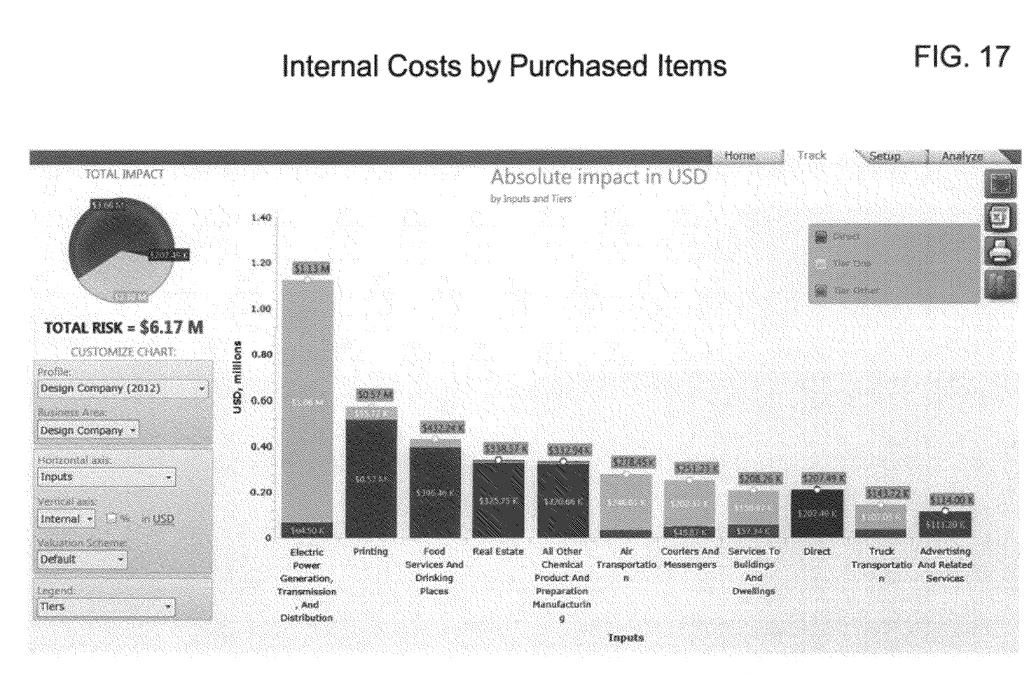

FIG. 17 is a screen shot of the internal costs of an organization by the items purchased by the industry and by the tier in the supply chain where the costs occur according to an embodiment of the present invention. In this example, the three environmental flows shown in FIG. 16 have been assigned an internal cost associated with regulatory compliance and reporting. Each item purchased by the organization has some amount of these three environmental flows in their supply chain. The “Direct” bar represents costs the organization is incurring for their direct environmental flows. The “Tier One” quantities represent costs being incurred as a result of tier 1 supplier's environmental flows. “Tier Other” quantities represents costs currently being incurred because of environmental flows beyond the first tier.

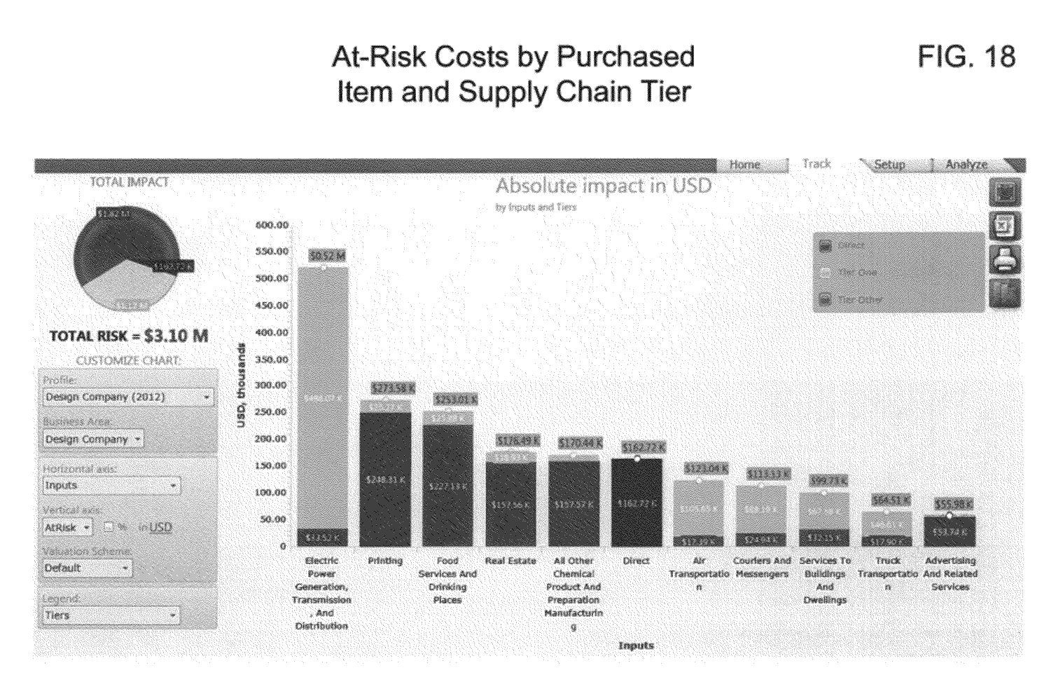

FIG. 18 is a screen shot of the estimated future costs associated with environmental flows within the supply chain of each industry the organization purchases from according to an embodiment of the present invention. These “at-risk” costs are shown broken down by the tier in the supply chain where the costs would occur.

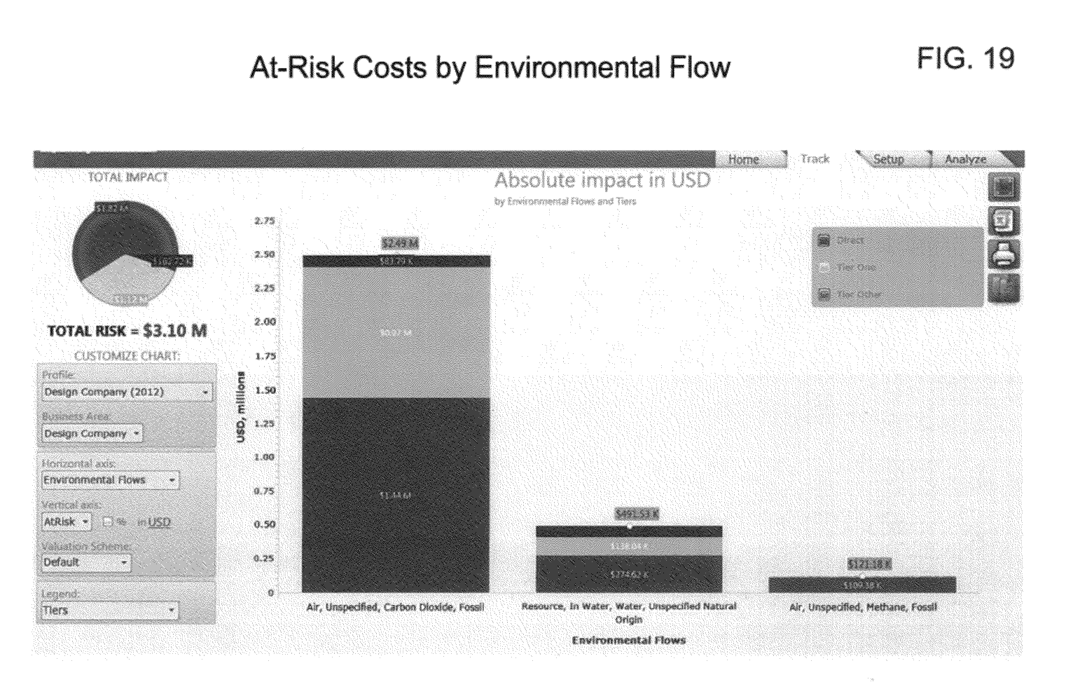

FIG. 19 is a screen shot of estimated future costs associated with an organization's environmental flows, broken down by the tier in the supply chain where the costs are expected to occur according to an embodiment of the present invention.

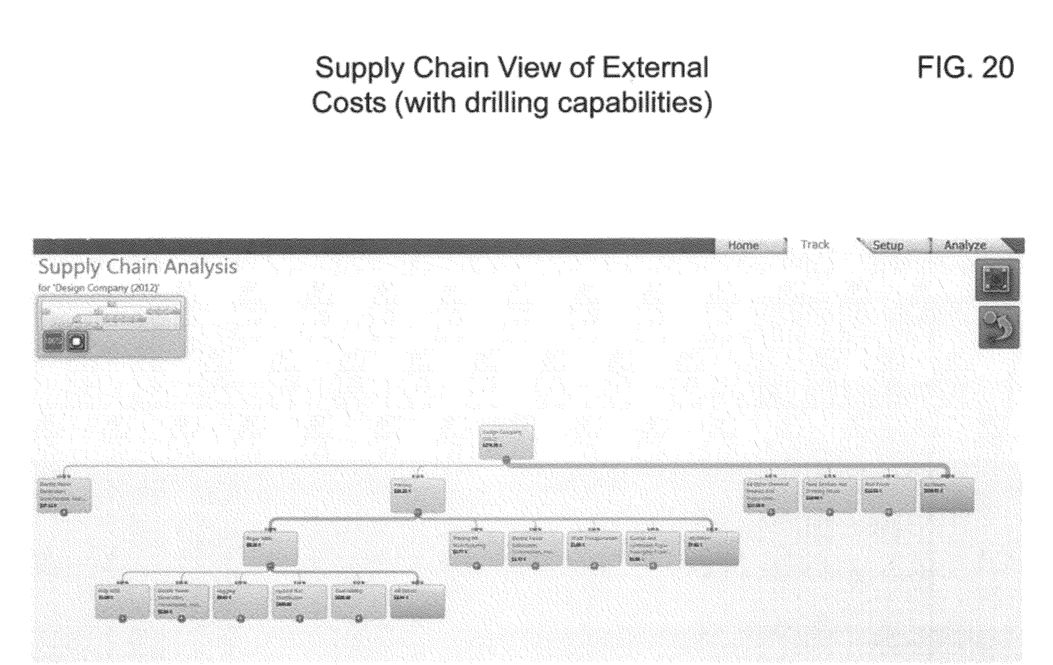

FIG. 20 illustrates one case of being able to view impacts in the supply chain of an organization, by tier, and by supplier, with the added ability to dynamically explore multiple tiers into the supply chain to explore what activities in the supply chain are contributing to higher level impacts and gain insight into the supply chain from an environmental and a financial perspective according to an embodiment of the present invention. In this example, the top 5 contributors to the design company, their printing suppliers, and their printing supplier's paper suppliers are shown.

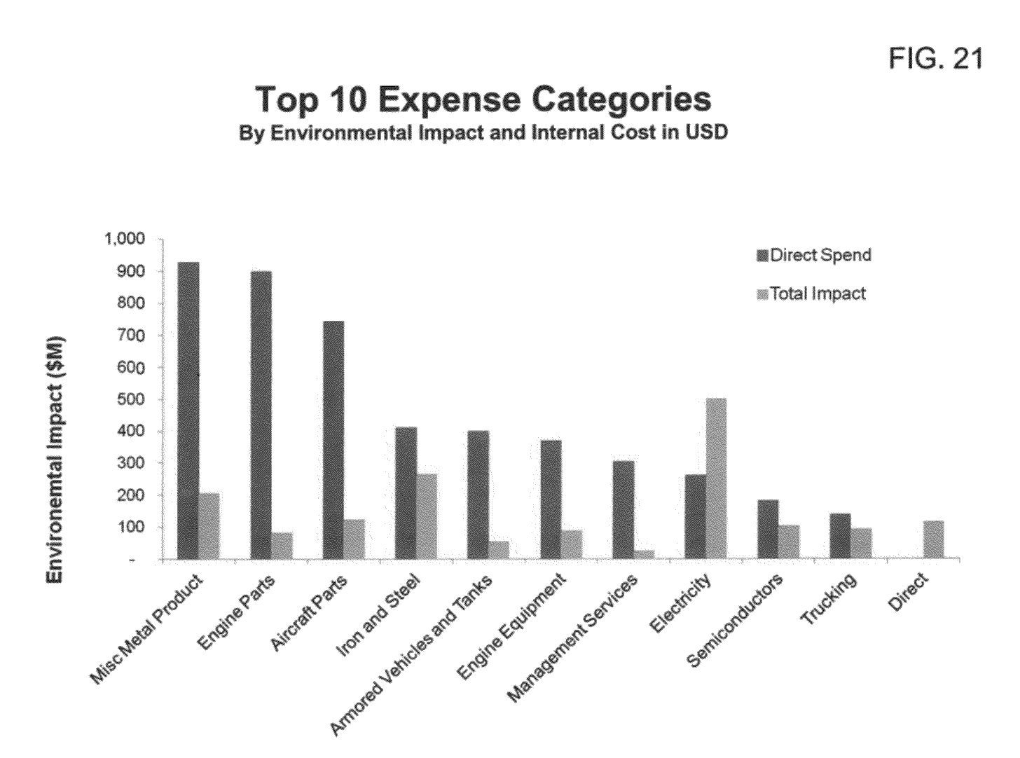

FIG. 21 illustrates the top 10 purchased items by an organization in terms of spend on each item and the total environmental impact of each item according to an embodiment of the present invention. FIG. 21 is similar to FIG. 13; FIG. 21 shows spend alongside the environmental impact (external cost) and does not break down the contribution by supply chain tier.

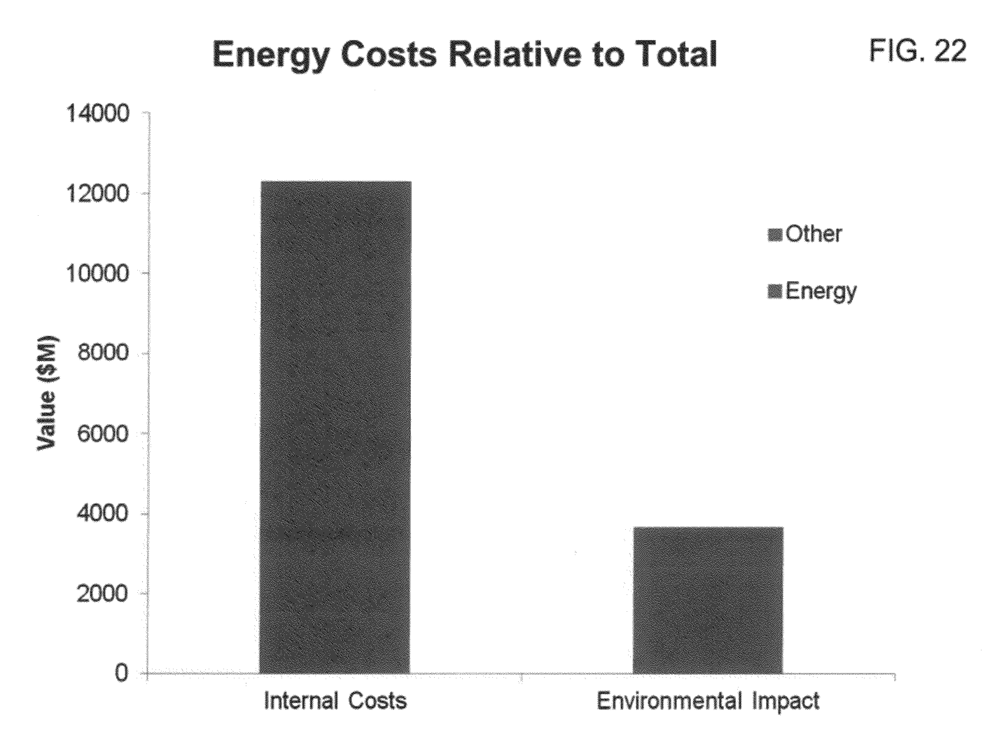

FIG. 22 illustrates the contribution of energy costs to the organization's total expenses and total environmental impacts according to an embodiment of the present invention. Internal costs associated with energy include the organization's spend on energy as well as all their supplier's spends on energy. Environmental Impacts associated with energy includes environmental flows across the supply chain typically associated with energy use such as carbon dioxide and particulates.

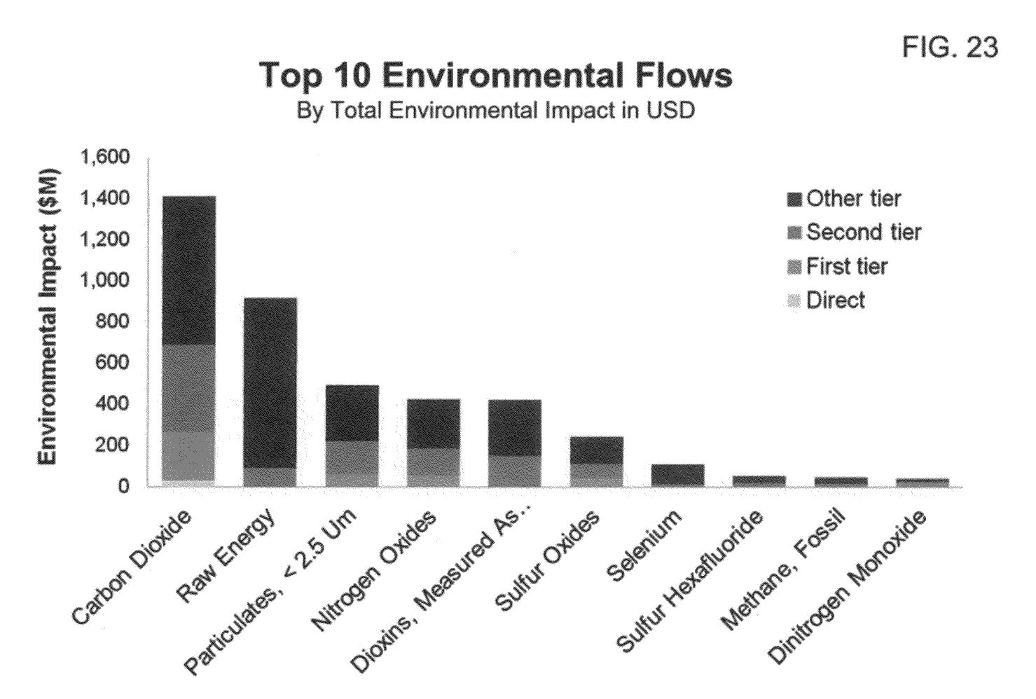

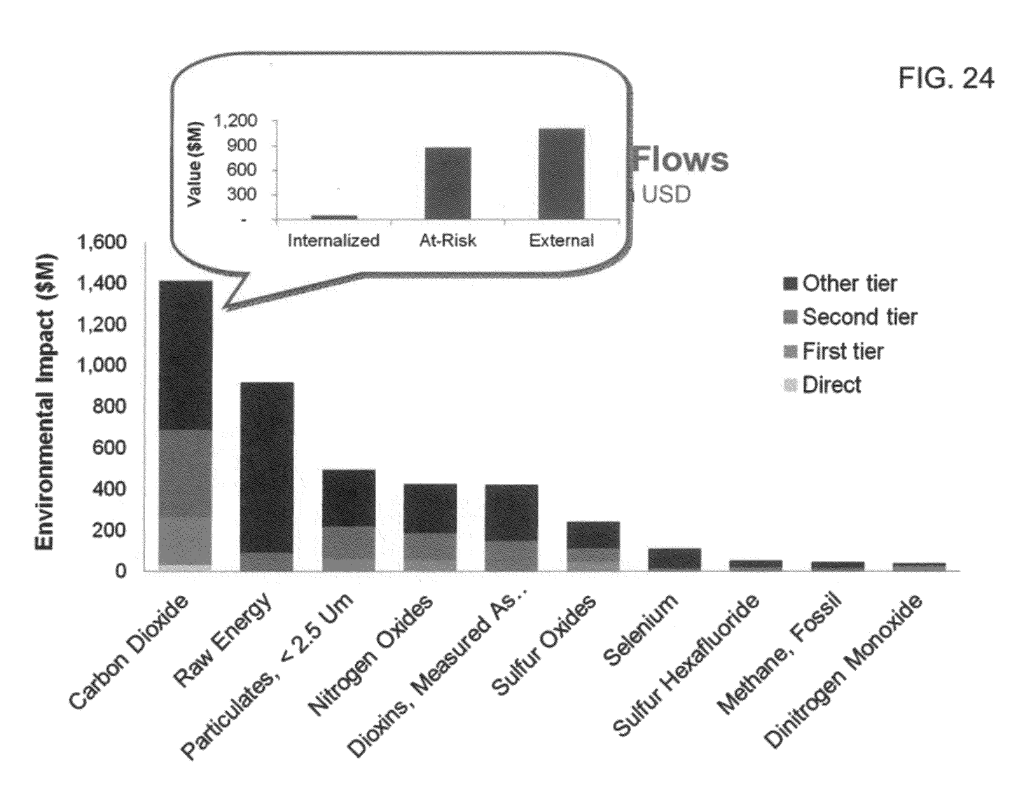

FIG. 23 and FIG. 24, similar to FIG. 14, illustrate the environmental impacts (external costs) of an organization shown by the specific environmental flow causing the environmental impact and by the tier in the supply chain where the impacts occur according to an embodiment of the present invention. In this example, carbon dioxide from fossil fuel combustion is the biggest contributor to environmental impacts with a small opportunity for reduction from carbon dioxide reductions within the organization and a big opportunity to work with 1st and 2nd tier suppliers on carbon dioxide mitigation through new technologies and efficiency.

In this example, the environmental value exposure (EVE), in terms of internalized, at-risk, and external costs, is illustrated for carbon dioxide. The internalized cost represents costs incurred by the organization today. The at-risk cost represents expected internal costs in 5 to 10 years due to changing regulations and reporting requirements. The external cost represents the costs incurred by society due to environmental impacts across the organization and its supply chain.

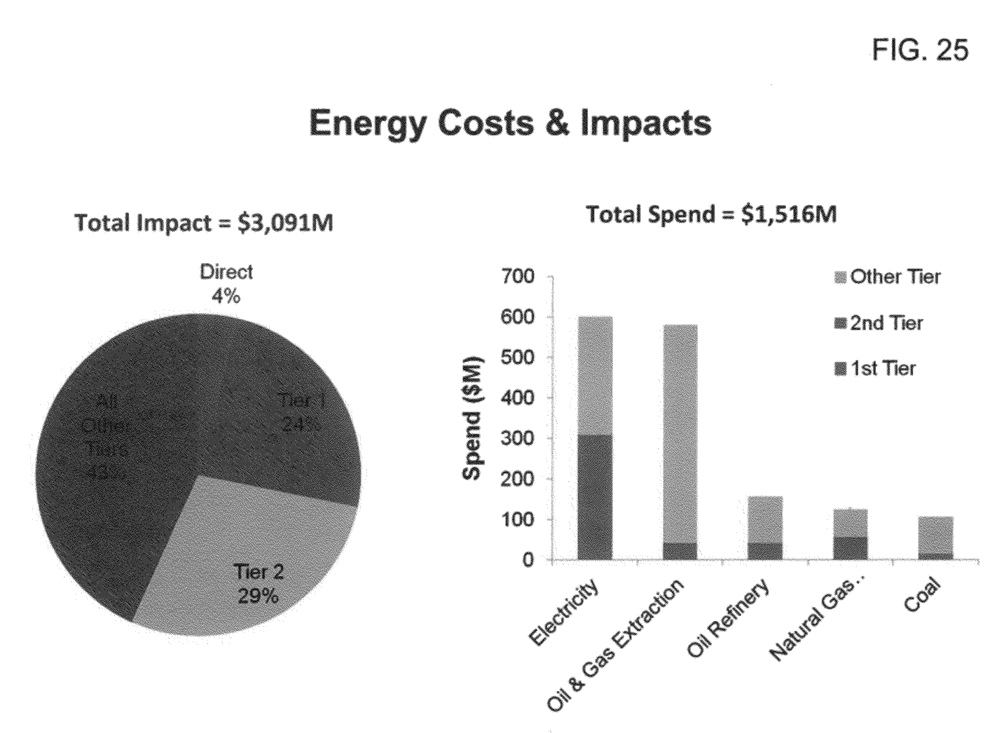

FIG. 25 illustrates, specifically for energy use, the environmental impacts in each tier of the supply chain, and the direct spend on energy throughout the supply chain according to an embodiment of the present invention. For example, the environmental impact associated with direct environmental flows from energy use (such as particulate and carbon dioxide releases form the organization's factories) represent 4% of the total impacts associated with energy related environmental flows. For example, the organization's spend on electricity is represented by the 1st tier portion of the electricity bar. The spend on electricity by suppliers is represented by the remainder of the electricity bar.

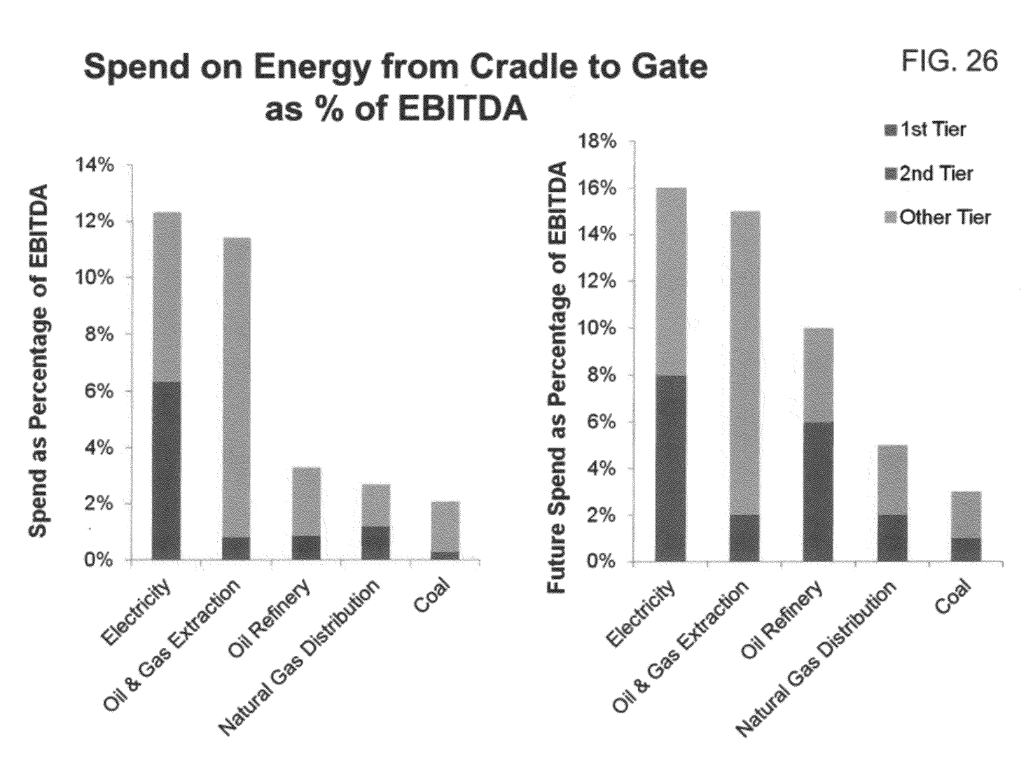

FIG. 26 illustrates the spend on energy related items (electricity, coal, natural gas, etc.) by an organization and its supply chain as a percentage of the organization's EBITDA according to an embodiment of the present invention. The chart on the right illustrates projected energy spend as a percentage of EBITDA associated with increasing energy prices in the future. The first tier quantity of spend represents the organization's spend on each energy related item. The second and other tiers represent spend by suppliers.

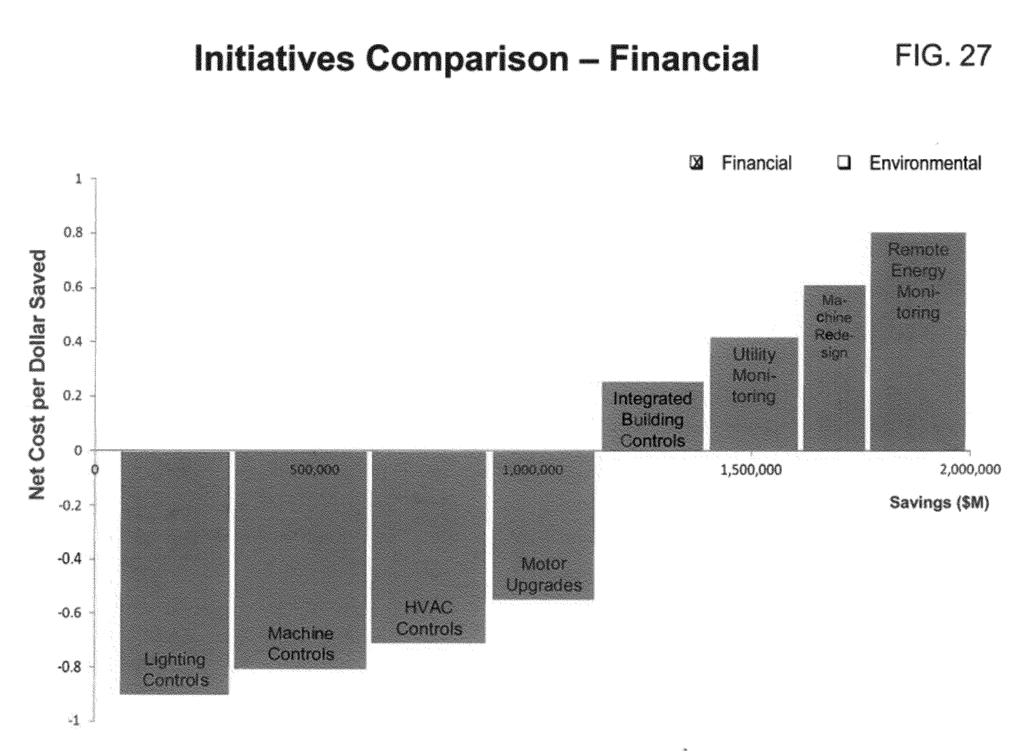

FIG. 27 illustrates a cost curve for various initiatives (mitigation activities) that an organization could undertake to reduce their environmental impacts according to an embodiment of the present invention. The height of each bar indicates the net of the savings and costs required for that initiative per dollar of savings from implementing the initiative. The width of the bar represents the total savings associated with implementing the initiative. In general, an organization would start with items on the left-hand side of this chart first because they have high return on investment.

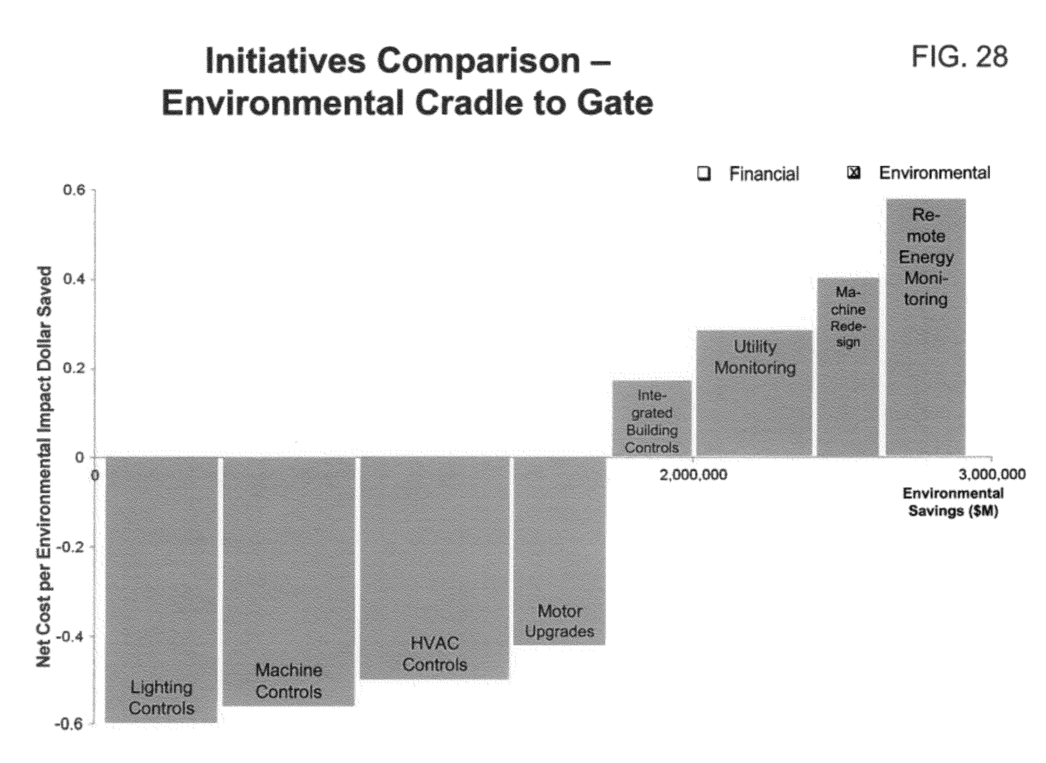

FIG. 28 illustrates an environmental cost curve for various initiatives (mitigation activities) that an organization could undertake to reduce their environmental impacts according to an embodiment of the present invention. The height of each bar indicates the net of the financial savings and costs required for that initiative per dollar of environmental impacts saved by the initiative. The width of the bar represents the total environmental savings associated with implementing the initiative.

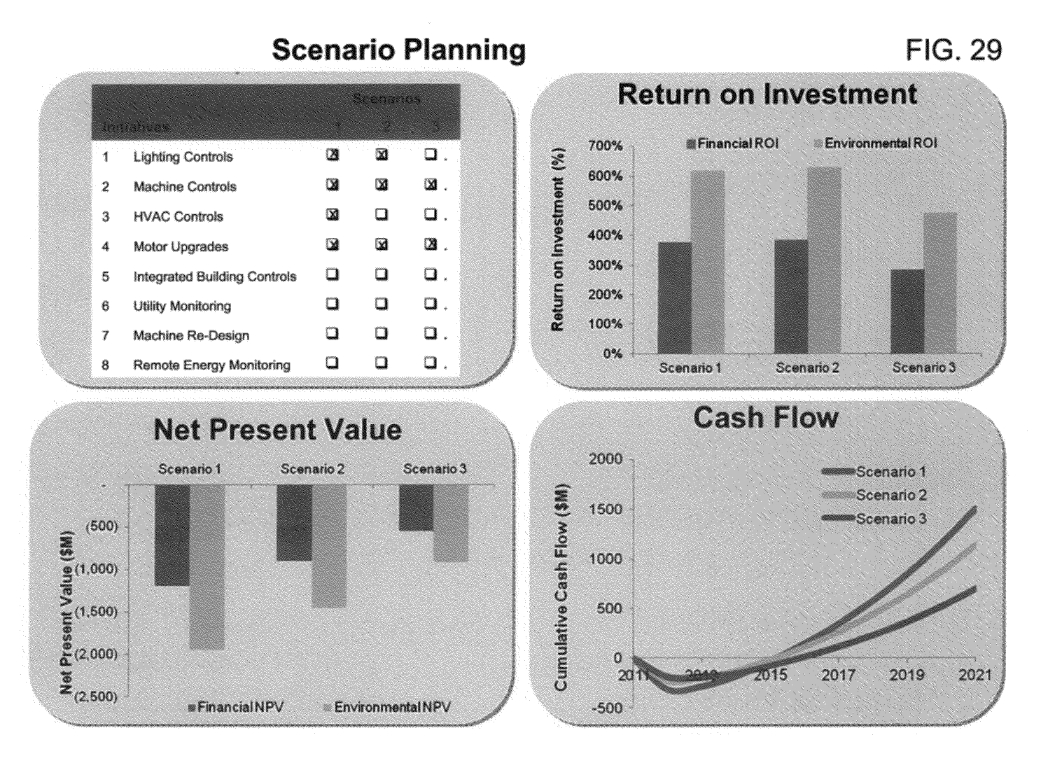

FIG. 29 illustrates a user generating multiple scenarios of the initiatives (mitigation activities) they might want to implement going forward according to an embodiment of the present invention. This allows a user to understand the financial and environmental tradeoffs between the initiatives in combination and establish a plan for the initiatives going forward. Once a scenario is chosen as a plan, the user can track their progress to the expected performance of the initiatives within that scenario.

The Return on Investment chart illustrates the traditional financial return on investment associated with each scenario alongside the environmental return on investment metric. Environmental return on investment is calculated as (NPV(environmental savings in $)+Financial investment)/(Financial Investment)

The Net Present Value chart illustrates the traditional financial net present value associated with each scenario alongside the environmental net present value metric.

The Cash Flow chart represents the traditional cumulative cash flow over time associated with each scenario.

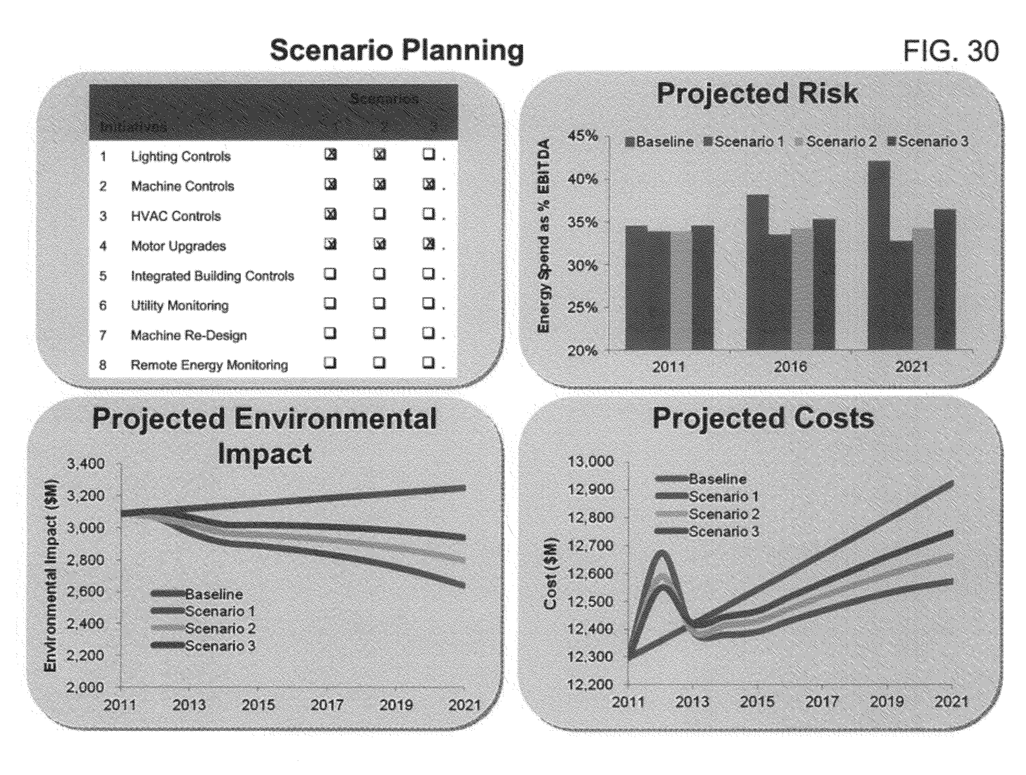

FIG. 30 is a second illustration of a user viewing the projected results of implementing various mitigation activities (initiatives) according to an embodiment of the present invention.

Projected risk illustrates the energy spend (total of spend from FIG. 26) as a percentage of EBITDA for 2011, 2016, and 2021 with and without the implementation of each mitigation scenario.

Projected environmental impact illustrates current environmental impacts valued in dollars and projected into the future given an organization's expected growth alongside projected reduced impacts associated with the implementation of each scenario.

Projected costs illustrates the organization's total spend in the future associated with their current growth projections (baseline) and the implementation of each scenario.

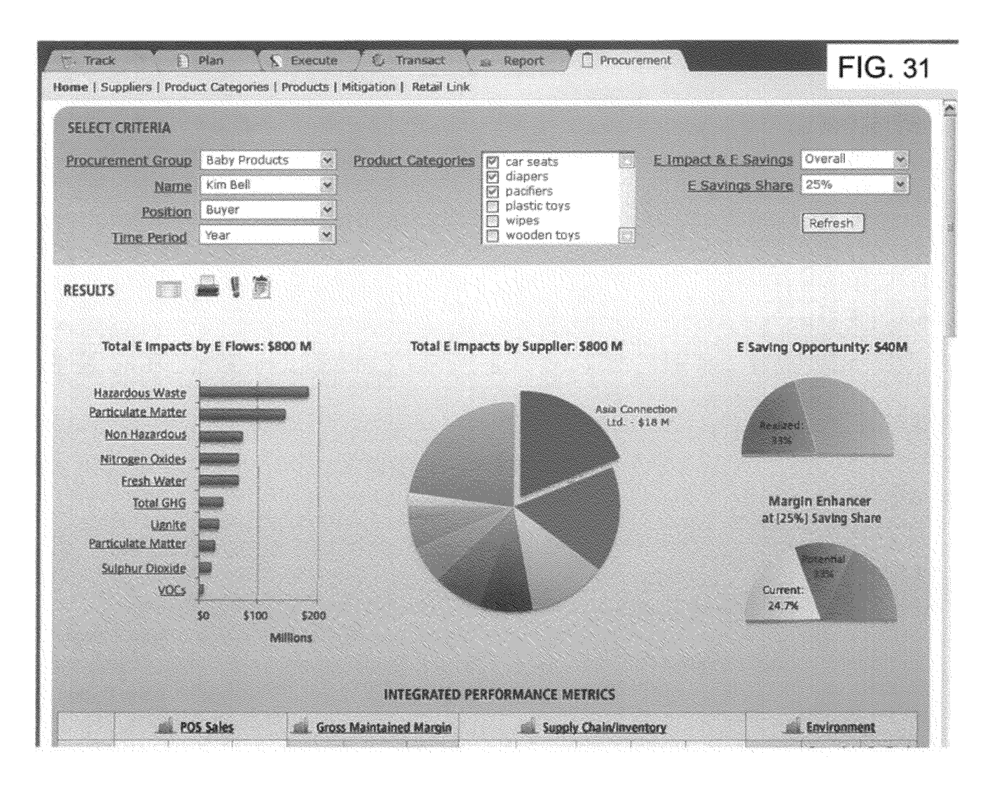

FIG. 31 illustrates the environmental impacts and savings opportunities associated with a selected set of product categories. This allows decision makers within procurement to make tradeoffs between particular suppliers within a product category and to understand opportunities to reduce costs and environmental impacts. Under “Select Criteria” a user is able to define what type of product and analysis will appear under “Results”.

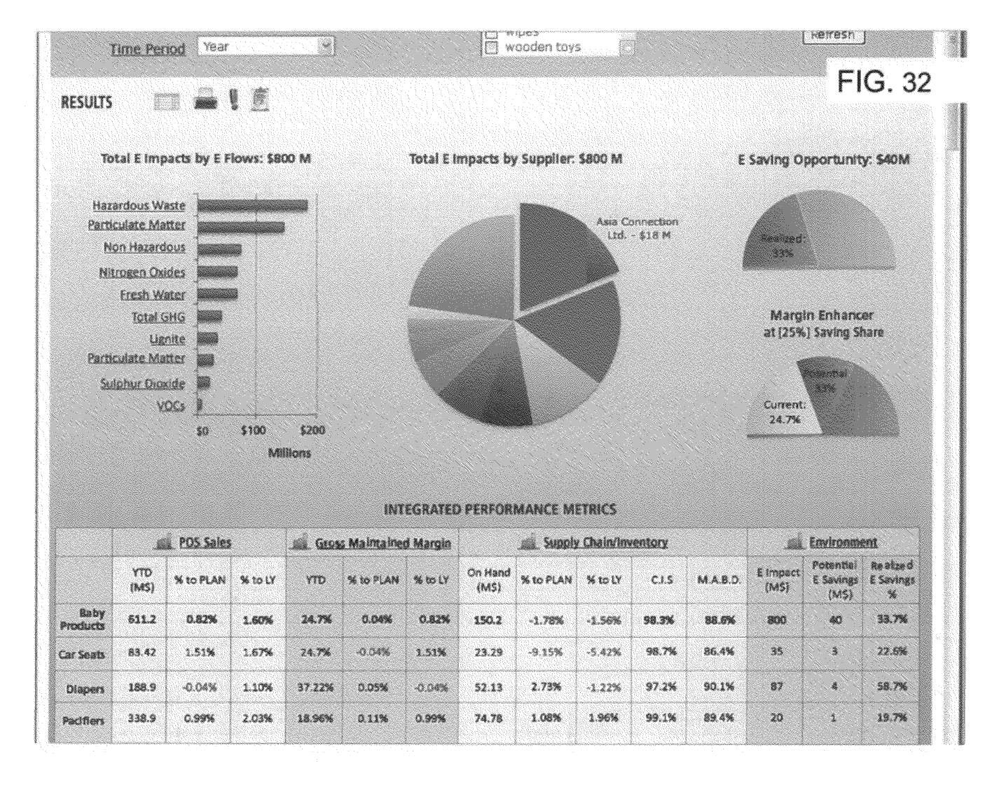

FIG. 32 is an extension of the page shown in FIG. 31 and illustrates the integrated performance metrics associated with the selected set of product categories. Integrated performance metrics provide information on the financial and environmental performance of each selected product category so they can be compared side by side. Information such as inventory levels, profit margin, sales, and environmental impacts can be quickly evaluated by a procurement officer as they make purchasing decisions on the products.

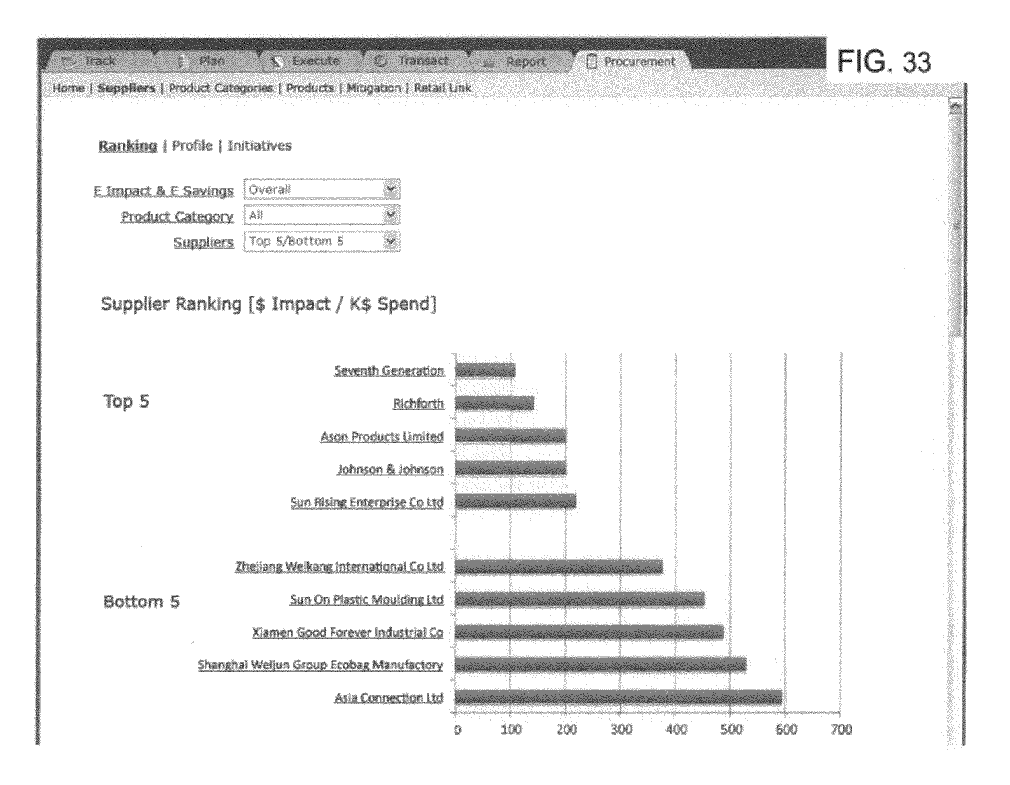

FIG. 33 illustrates the suppliers who are the best and worst performers both financially and environmentally across all product categories. The selectors at the top of the page would also allow the user to select to view a particular product category or to focus on environmental or financial value rather than the combination of the two being used in this chart. The ranking of the suppliers is shown according to their relative intensity (impact/spend), so that a high performing supplier can be identified even if they are not currently a large provider to the organization.

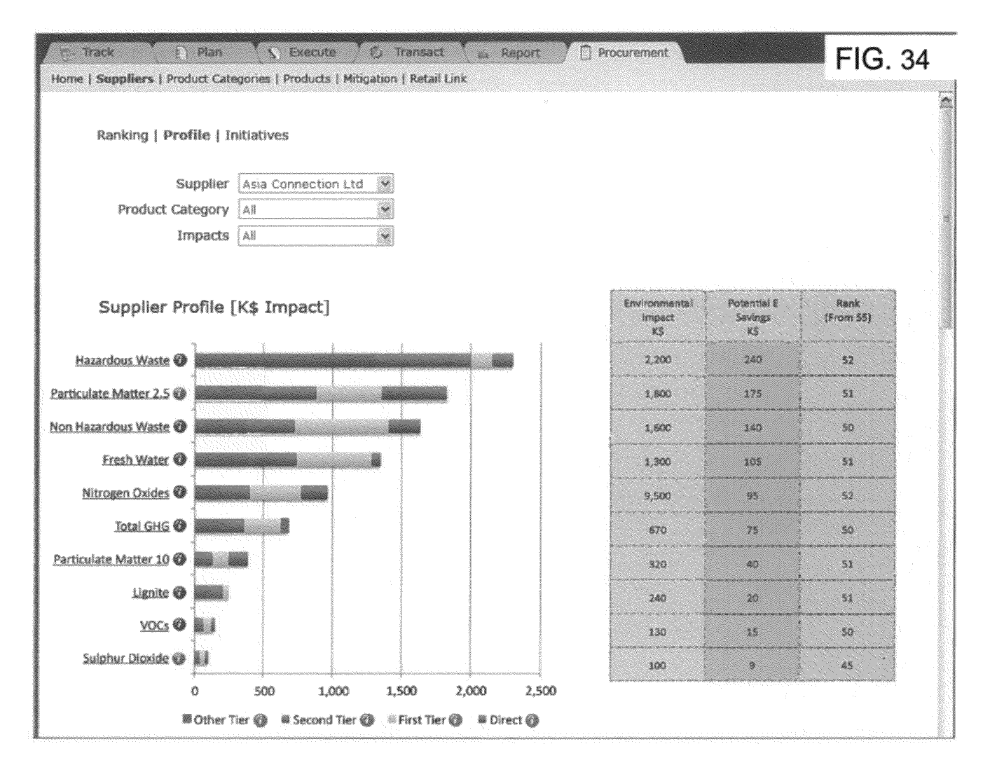

FIG. 34 illustrates details on the environmental and financial performance of a particular supplier. A user may move to this view to better understand insights on the supplier ranking obtained in the view shown by FIG. 33. In this example, the impacts associated with all products provided by Asia Connection Ltd are shown by their environmental impact across the supply chain and by the potential for environmental reduction associated with each environmental flow.

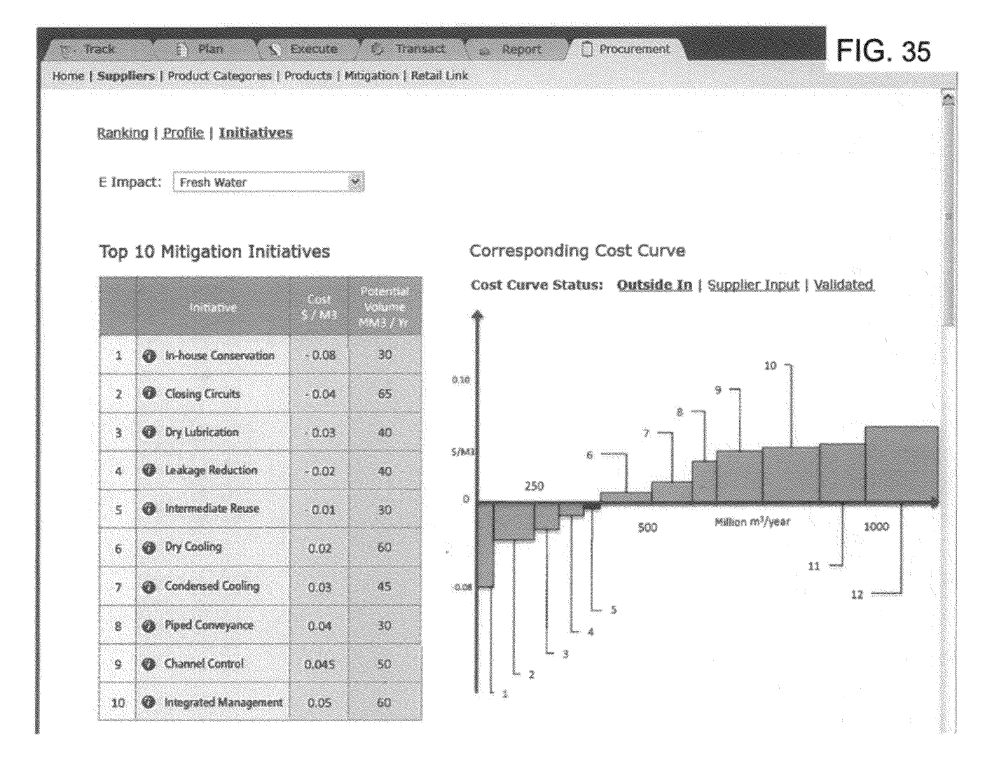

FIG. 35 illustrates a number of mitigation opportunities that could be implemented with various suppliers. These mitigation opportunities are ranked from high to low savings, where mitigation projects at the bottom of the table or the far right of the cost curve would cost money to implement over their lifetime and projects at the left save money over their lifetime. In this example, mitigation opportunities specific to fresh water have been selected and therefore the cost savings are per cubic-meter of water saved.

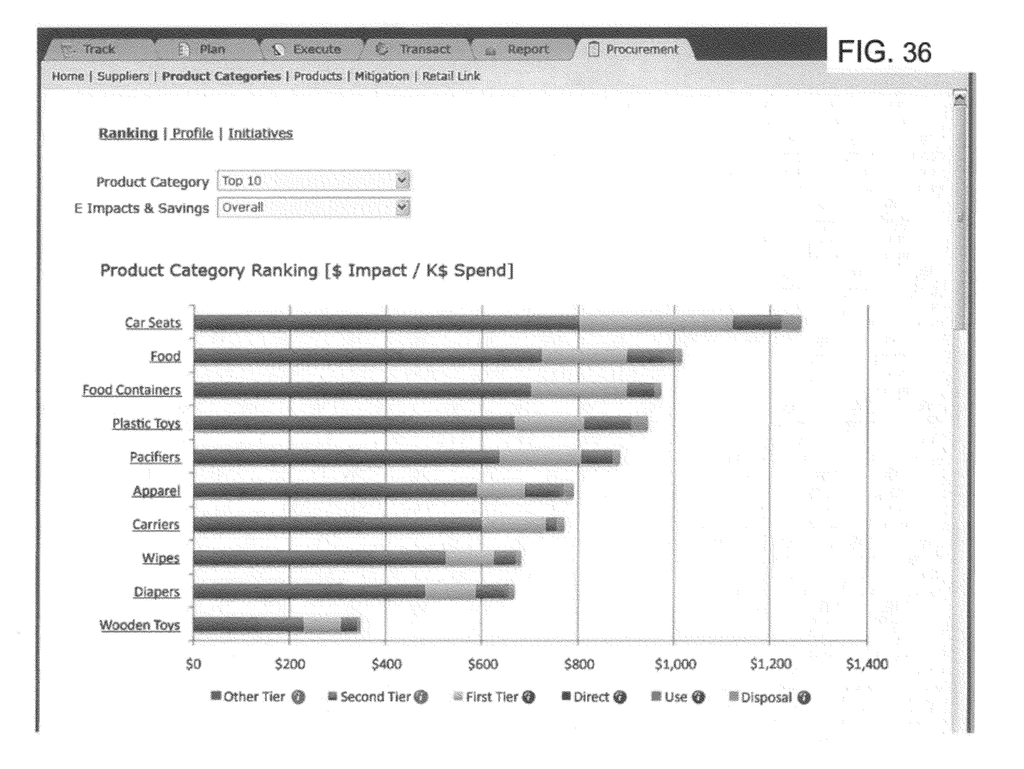

FIG. 36 illustrates a ranking of the top 10 most impacting product categories purchased by the organization. The environmental impacts are shown normalized by the quantity of spend on each product category, and broken down by the tier in the supply chain (including downstream and upstream) where the impact occurs.

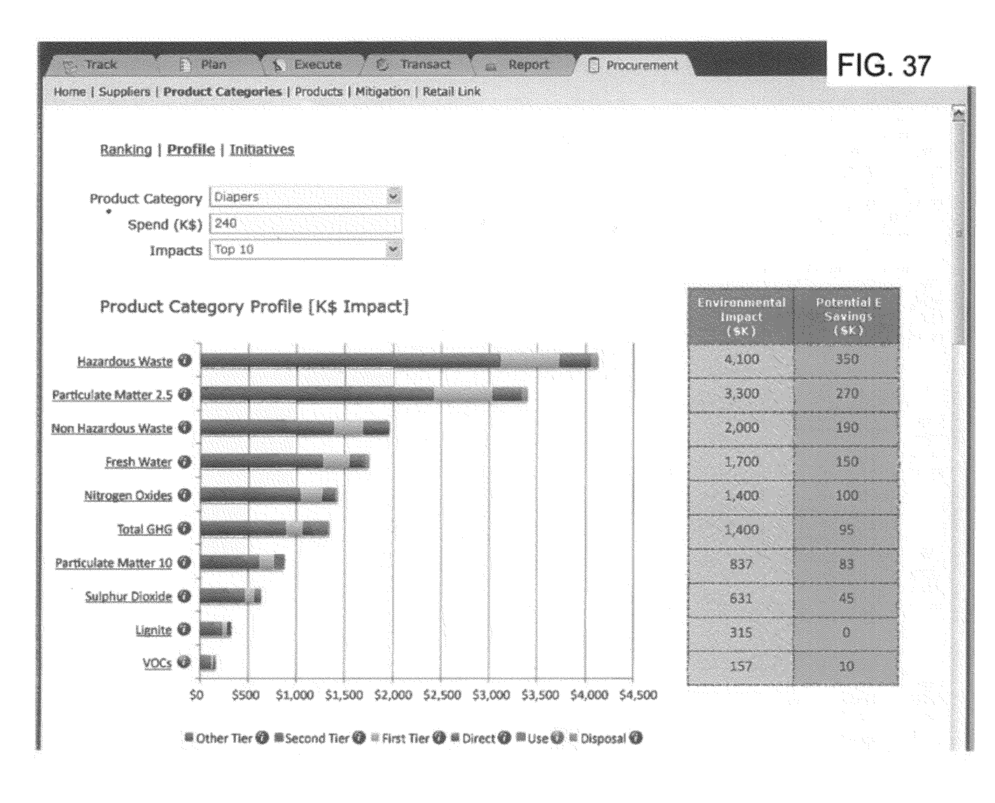

FIG. 37 illustrates, for a selected product category, the top 10 environmental flows contributing to the environmental impacts of that product category and the potential for mitigating those environmental impacts through mitigation activities such as equipment replacement or retrofits. Again, the environmental flows are shown by where in the supply chain the impacts occur.

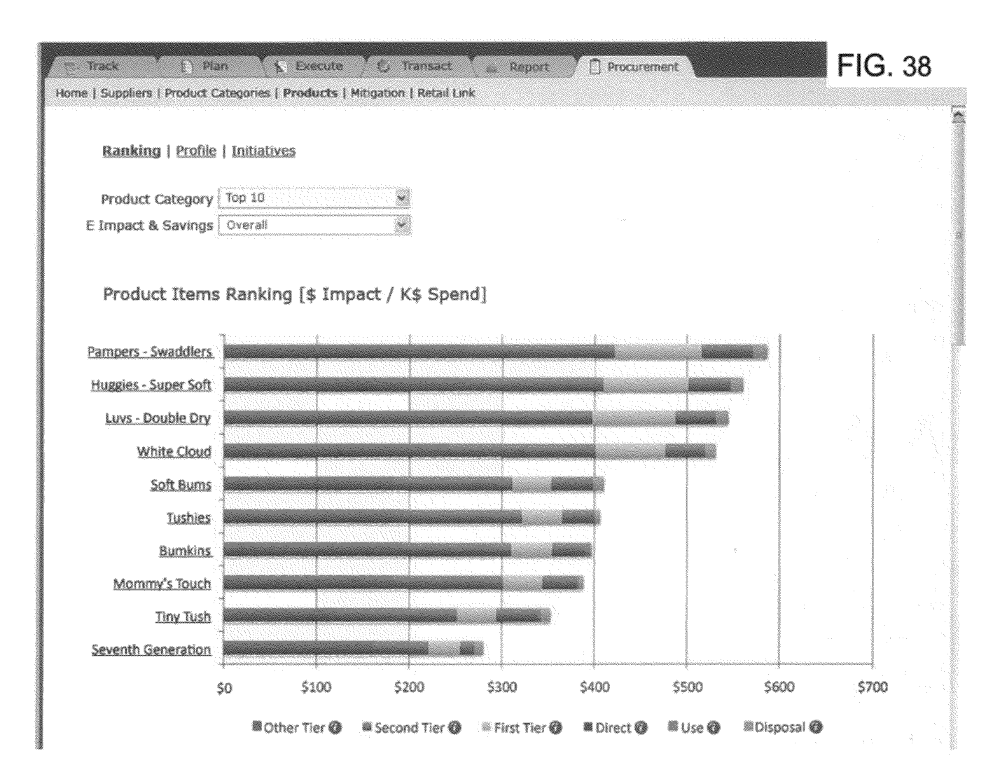

FIG. 38 illustrates the ranking of specific products by their environmental impact. Again, the environmental flows are shown by where in the supply chain the impacts occur and the bars represent the total impact per dollar spent on that product so that products of particular interest because of their low or high impact intensity become clear for procurement decision makers. For example, the “Pampers-Swaddlers” in this example has a high impact per dollar spent, but the Seventh Generation diaper is roughly half the impact. The procurement person may use this information to decide to reduce their spend on Pampers and scale up spend on Seventh Generation; thus reduction the organization's footprint through procurement decision-making.

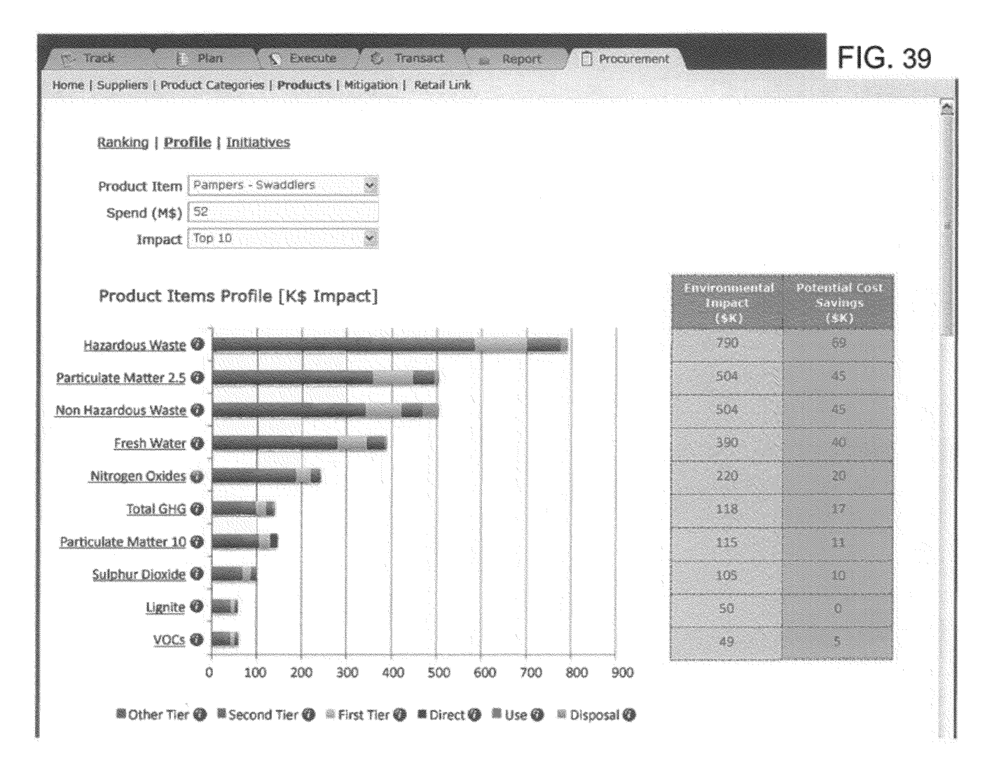

FIG. 39 illustrates, for a specific product, the top 10 environmental flows contributing to the environmental impacts and the potential for mitigating those environmental impacts through mitigation activities such as building controls or leakage reductions. The environmental flows are shown by where in the supply chain the impacts occur.

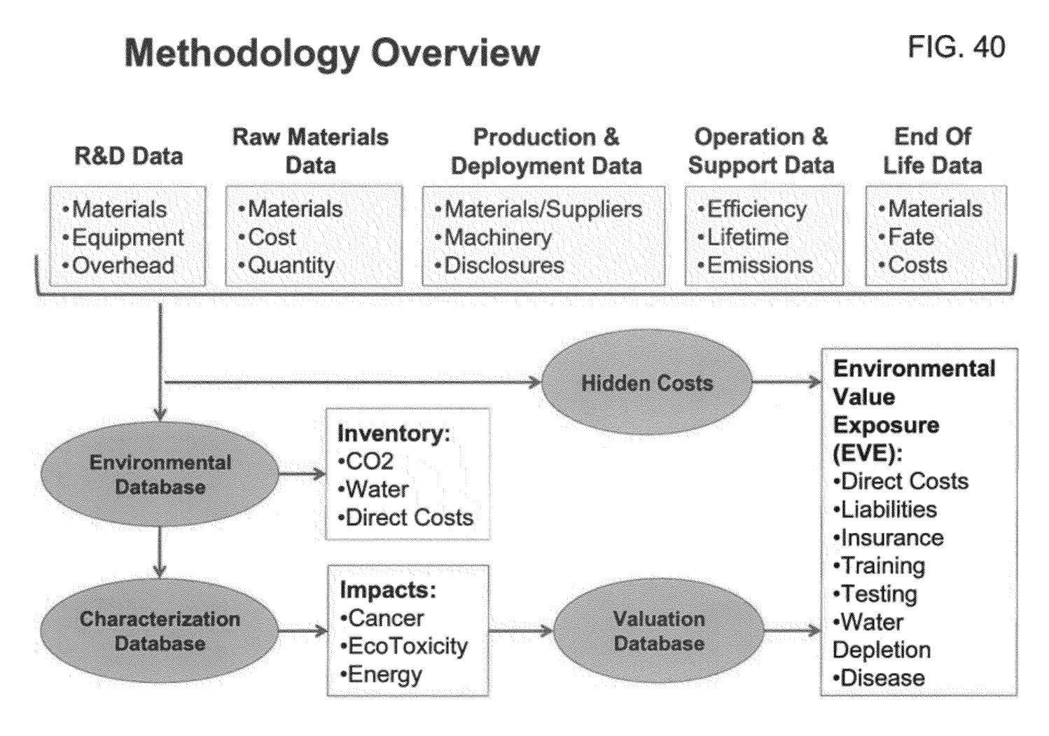

FIG. 40 illustrates the big picture on how organizational or product data on activities throughout production and use are combined and merged with an environmental data to first produce an inventory of environmental flows that are then passed through a characterization database to determine the midpoint and endpoint impacts associated with those environmental flows, which are then assigned an internal, external, and at-risk valuation to obtain the final cost associated with those environmental flows. In parallel hidden and contingent costs associated with each activity, industry, and/or product are merged with the company or product data on activities to obtain estimates of hidden and contingent costs. The combination of these various costs represents a comprehensive environmental value exposure (EVE) associated with the full lifecycle of an organization (including supply chain and customer) activities.

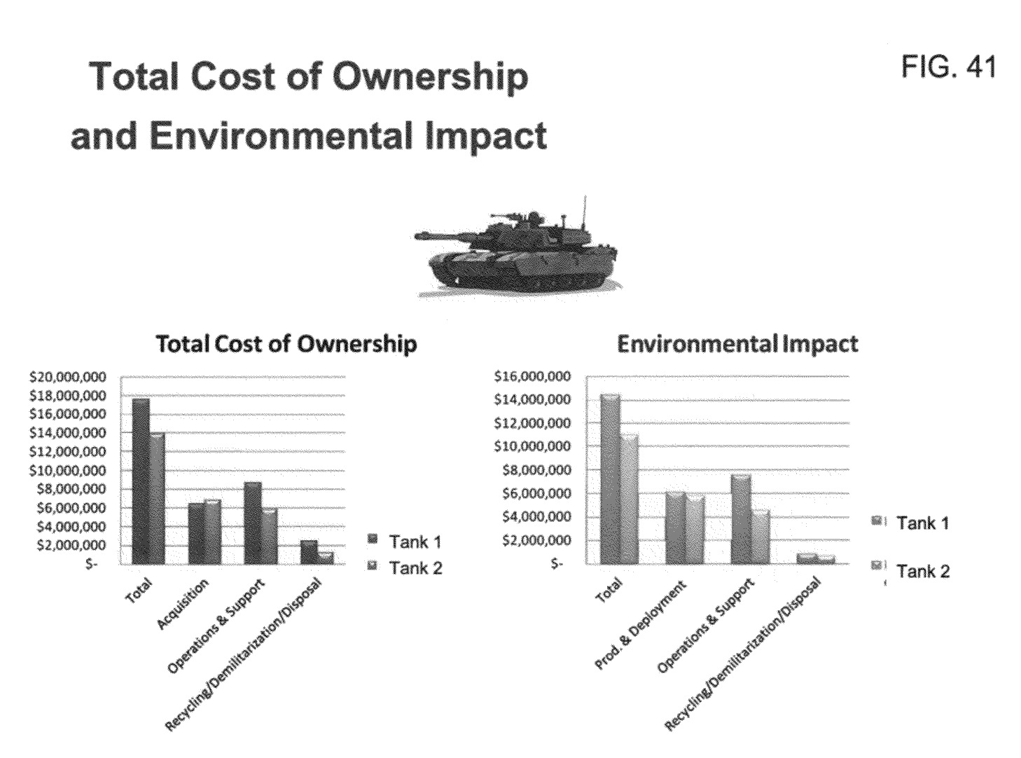

FIG. 41 illustrates a comparison of the total cost of ownership both financially and environmentally for two equivalent tank designs. Financially, the total cost of ownership for someone buying a product includes the purchasing or acquisition cost, the cost of using and maintaining the product (including hidden costs associated with training and upgrades, for example) and the disposal of the product. Environmentally, the total impacts include the production of the product (cradle to gate) the use of the product (including fuel consumption and parts replacements, for example) and disposal (or recycling, or re-manufacturing) of the product.

In LCA, a “gate” generally refers to when a product moves from one stage of the supply chain to the next. Cradle to gate means from materials extraction (or raw materials from scrap) through when a product is sold by the organization. Therefore, cradle to gate does not include impacts from use of the product (e.g. a computer's electricity use) or end of life (recycling or landfill). Cradle to grave covers impacts from raw materials through when the item ends its life and is sent to be recycled, remanufactured, or landfilled.

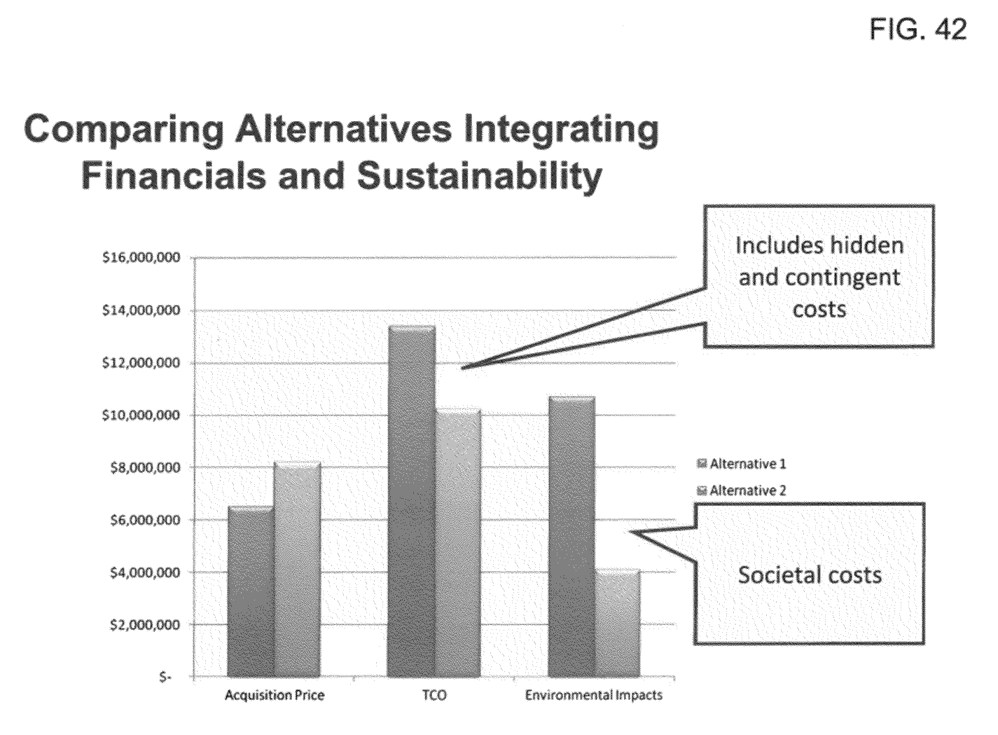

FIG. 42 illustrates the integration of financials and environmental impact when comparing costs associated with two equivalent products. Acquisition price is the price an organization pays for the item upfront. The total cost of ownership (TCO) (also known as Total Ownership Cost, TOC) represent the acquisition price plus use-phase costs associated with energy, maintenance, and training, for example. The Environmental impact cost represents the societal costs associated with environmental releases and use of environmental resources throughout the lifecycle of the organization, company, product, plant, or entity being analyzed.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A method for assessing costs associated with an organization and/or its supply chain, the method comprising:
accessing a first set of data relating to the organization and/or the supply chain, wherein the first set of data includes environmental flows, products data, and/or activities data associated with the organization and/or the supply chain;
accessing one or more databases indexed by at least a portion of the environmental flows, products data, and/or activities data, the one or more databases comprising one or more of:
a database including societal costs, the societal costs representing costs external to the organization and the supply chain;
a database including current internal costs, the current internal costs representing costs internalized by the organization or the supply chain; and
a database including future internal costs, the future internal costs representing costs projected to be internalized by the organization or the supply chain; and
applying the first set of data to the one or more databases to produce a corresponding one or more cost data, the one or more cost data representing the costs associated with the organization or the supply chain, the one or more cost data comprising a corresponding one or more of:
societal cost data;
current internal cost data; and
future internal cost data.

2. The method of claim 1, further comprising summing the one or more cost data to produce an environmental value exposure (EVE) for the organization or the supply chain.

3. The method of claim 1, wherein the one or more databases comprises two or more of the database including societal costs, the database including current internal costs, and the database including future internal costs.

4. The method of claim 3, wherein the one or more databases comprises the database including societal costs, the database including current internal costs, and the database including future internal costs.

5. The method of claim 1, wherein the costs are expressed in monetary terms.

6. The method of claim 1, further comprising:
accessing a database including ordinary, hidden, or contingent costs indexed by at least a plurality of organization types and/or the environmental flows, the ordinary, hidden, or contingent costs representing costs associated with ownership and internalized by the organization or the supply chain; and
applying organization type or environmental flow data of the organization or the supply chain to the database including ordinary, hidden, or contingent costs to produce total cost of ownership (TCO) data.

7. The method of claim 6, further comprising summing the one or more cost data and the TCO data to produce an environmental value exposure (EVE) for the organization or the supply chain.

8. The method of claim 6, wherein the plurality of organization types comprises products or industries.

9. The method of claim 6, further comprising:
accessing a second set of data relating to the organization, wherein the second set of data includes the environmental flows for a use and disposal phase of ownership; and
applying the second set of data to at least one of the database including current internal costs or the database including future internal costs to supplement the TCO data.

10. The method of claim 9, further comprising modeling the organization to produce the second set of data.

11. The method of claim 1, further comprising modeling the organization and/or the supply chain to produce the first set of data.

12. The method of claim 11, wherein the modeling is done using Process Life Cycle Assessment (LCA), economic input output (EIO) LCA, integrated hybrid LCA (IHLCA), tiered hybrid LCA, EIO hybrid LCA, and combinations thereof.

13. The method of claim 12, wherein the modeling of the organization and the supply chain is done using IHLCA.

14. The method of claim 1, further comprising producing the database including societal costs, the producing of the database including societal costs comprising applying a database including societal costs associated with a plurality of environmental midpoints or endpoints to a database including characterizations of the environmental flows into the plurality of environmental midpoints or endpoints.

15. The method of claim 1, further comprising producing the database including future internal costs, the producing of the database including future internal costs comprising calculating non-regulatory cost projections for the environmental flows, products data, and/or activities data.

16. The method of claim 1, further comprising producing the database including future internal costs, the producing of the database including future internal costs comprising estimating an impact of regulatory changes on costs of the environmental flows, products data, and/or activities data.

17. A system for assessing costs associated with an organization and/or its supply chain, the system comprising:
a computer processor configured to obtain a first set of data relating to the organization and/or the supply chain, wherein the first set of data includes environmental flows, products data, and/or activities data associated with the organization and/or the supply chain,
the computer processor coupled to one or more databases indexed by at least a portion of the environmental flows, products data, and/or activities data, the one or more databases comprising one or more of:
a database including societal costs, the societal costs representing costs external to the organization and the supply chain;
a database including current internal costs, the current internal costs representing costs internalized by the organization or the supply chain; and
a database including future internal costs, the future internal costs representing costs projected to be internalized by the organization or the supply chain, and
wherein the computer processor is configured to apply the first set of data to the one or more databases to produce a corresponding one or more cost data, the one or more cost data representing the costs associated with the organization or the supply chain, the one or more cost data comprising a corresponding one or more of:
societal cost data;
current internal cost data; and
future internal cost data.

18. The system of claim 17, wherein the computer processor is further configured to sum the one or more cost data to produce an environmental value exposure (EVE) for the organization or the supply chain.

19. The system of claim 17, wherein the one or more databases comprises two or more of the database including societal costs, the database including current internal costs, and the database including future internal costs.

20. The system of claim 19, wherein the one or more databases comprises the database including societal costs, the database including current internal costs, and the database including future internal costs.

21. The system of claim 17, wherein the costs are expressed in monetary terms.

22. The system of claim 17, wherein the computer processor is further configured to:
access a database including ordinary, hidden, or contingent costs indexed by at least a plurality of organization types and/or the environmental flows, the ordinary, hidden, or contingent costs representing costs associated with ownership and internalized by the organization or the supply chain; and
apply organization type or environmental flow data of the organization or the supply chain to the database including ordinary, hidden, or contingent costs to produce total cost of ownership (TCO) data.

23. The system of claim 22, wherein the computer processor is further configured to sum the one or more cost data and the TCO data to produce an environmental value exposure (EVE) for the organization or the supply chain.

24. The system of claim 22, wherein the computer processor is further configured to:
access a second set of data relating to the organization, wherein the second set of data includes the environmental flows for a use and disposal phase of ownership; and
apply the second set of data to at least one of the database including current internal costs or the database including future internal costs to supplement the TCO data.

25. A system for enabling organizations to collaborate with respect to environmental impact mitigation plans and an effectiveness thereof, the system comprising:
a server computer coupled to a plurality of client computers individually accessible by users in a plurality of distinct organizations, wherein the server computer is coupled to a database that includes the environmental impact mitigation plans and results indicating the effectiveness thereof, the plans and results indexed by product, industry, or environmental concern,
wherein the system is configured to:
enable the users in the distinct organizations to access the plans;
receive successively updated plans and updated results from users in the distinct organizations based on an actual implementation of the plans by the organizations; and
enable the users to access the updated plans and updated results from the system, and
wherein the database is populated with successively updated plans and results from various distinct organizations over time, thereby enabling the users in the distinct organizations to access augmented and optimized environmental mitigation plans for implementation therein.
